(19) United States
(12) Patent Application Publication
(10) Pub. No.: US 2016/0162092 A1
(43) Pub. Date: Jun. 9, 2016

(54) OPERATION DEVICE

(71) Applicant: FUJITSU TEN LIMITED, Kobe-shi (JP)

(72) Inventors: Osamu KUKIMOTO, Kobe-shi (JP); Teru SAWADA, Kobe-shi (JP); Tadayuki YAMASHITA, Kobe-shi (JP); Masahiro IINO, Kobe-shi (JP)

(73) Assignee: FUJITSU TEN LIMITED, Kobe-shi (JP)

(21) Appl. No.: 14/957,340

(22) Filed: Dec. 2, 2015

(30) Foreign Application Priority Data
Dec. 8, 2014 (JP) 2014-247818
Dec. 8, 2014 (JP) 2014-247819

(51) Int. Cl. G06F 3/041; G06F 3/16

(52) U.S. Cl. CPC G06F 3/0414; G06F 3/167

(57) ABSTRACT

An operation device, includes: a touch sensor; a deriving unit that acquires information representing a point on the touch sensor subjected to an operation, and derives an amount of the operation on the basis of the point information; and a tactile sensation giving unit that gives a tactile sensation to an operator, in which the tactile sensation giving unit gives a first tactile sensation at intervals of a first operation amount from an operation start point.

### CROSS-REFERENCE TO RELATED APPLICATIONS

This application is based on and claims priority under 35 USC 119 from Japanese Patent Application No. 2014-247818, filed on Dec. 8, 2014 and Japanese Patent Application No. 2014-247819, filed on Dec. 8, 2014.

### BACKGROUND

1. Technical Field

The present invention relates to an operation device.

2. Related Art

In the past, when a user operated a touch panel, the physical location of the touch panel did not change. Therefore, the user couldn't get feedback on the operation and thus couldn't get a sense of the operation. For this reason, there are known technologies for vibrating a touch pane if a user operates the touch panel such that the user gets feedback on the operation. Also, an example of the technologies related to the present invention has been disclosed in JP-A-2012-027765.

### SUMMARY OF INVENTION

However, since the related technologies just vibrate a touch panel if a user touches the touch panel, the user cannot get feedback on the corresponding operation and thus cannot recognize what type of operation has been performed. In order to improve user friendliness, it is required for the user to intuitively recognize the content of each operation.

In view of the above, an object of the present invention is to provide a technology capable of providing intuitive feedback if a user operates a touch panel.

[1] An aspect of the present invention provides an operation device, including: a touch sensor; a deriving unit that acquires information representing a point on the touch sensor subjected to an operation, and derives an amount of the operation on the basis of the point information; and a tactile sensation giving unit that gives a tactile sensation to an operator, in which the tactile sensation giving unit gives a first tactile sensation at intervals of a first operation amount from an operation start point.

[2] It may be the operation device according to [1], in which: the tactile sensation giving unit gives a second tactile sensation different from the first tactile sensation at intervals of a second operation amount different from the first operation amount.

[3] It may be the operation device according to [1] or [2], further including: a voice output unit that outputs a voice, in which, in response to the tactile sensation giving unit giving the tactile sensation, the voice output unit outputs a voice corresponding to a type of the given tactile sensation.

[4] Another aspect of the present invention provides an operation device, including: a touch sensor; a deriving unit that acquires information representing a point on the touch sensor subjected to an operation, and derives an amount of the operation on the basis of the point information; and an adjusting unit that changes an adjustment value of another electronic device, in which, the adjusting unit perform an adjustment in accordance with the operation amount from an operation start point, from a current adjustment value a point of which is set to be associated with the operation start point.

[5] Another aspect of the present invention provides an operation device, including: a touch sensor; a deriving unit that acquires information representing a point on the touch sensor subjected to an operation, and derives an amount of the operation on the basis of the point information; and an adjusting unit that changes an adjustment value of another electronic device, in which, the adjusting unit performs an adjustment in accordance with the operation amount from an operation start point, from a adjustment value corresponding to a point of which is determined in advance and corresponds to an operation start point.

[6] Another aspect of the present invention provides an operation device, including: a touch sensor; a deriving unit that acquires information representing a point on the touch sensor subjected to an operation, and derives an amount of the operation on the basis of the point information; and an adjusting unit that changes an adjustment value of another electronic device, in which, the adjusting unit perform an adjustment in accordance with the operation amount from an operation start point, from an adjustment value a point of which is determined according to a trajectory of the operation and corresponds to an operation start point.

[7] It may be the operation device according to any one of [4] to [6], further including: a tactile sensation giving unit that gives a tactile sensation to an operator.

[8] It may be the operation device according to [7], in which: the tactile sensation giving unit gives the tactile sensation whenever the operation is performed by a predetermined amount.

[9] It may be the operation device according to [8], in which: the tactile sensation giving unit changes the predetermined amount depending on an operation target.

[10] It may be the operation device according to any one of [7] to [9], further including: a voice output unit that outputs a voice, in which, in response to the tactile sensation giving unit giving the tactile sensation, the voice output unit outputs the voice corresponding to a type of the given tactile sensation.

[11] An aspect of the present invention provides an operation device, including: a touch sensor; a determining unit that determines a content of an operation on the touch sensor; and a tactile sensation giving unit that gives a tactile sensation to an operator, in which, in response to the determining unit determining start of the operation on the touch sensor, the tactile sensation giving unit gives the tactile sensation corresponding to the content of the operation.

[12] It may be the operation device according to [11], in which: in response to the determining unit determining finish of the operation on the touch sensor, the tactile sensation giving unit gives a tactile sensation different from the tactile sensation given during the start of the operation.

[13] It may be the operation device according to [12], further including: a voice output unit that outputs a voice, in which, in response to the tactile sensation giving unit gives the tactile sensation during the finish of the operation, the voice output unit outputs the voice corresponding to a type of the given tactile sensation.

[14] It may be the operation device according to [11], in which: the determining unit acquires information representing a point on the touch sensor subjected to the operation, and derives an amount of the operation on the basis of the point information, and at intervals of a predetermined operation amount, the tactile sensation giving unit gives a tactile sensation different from the tactile sensation given during start of the operation.

[15] It may be the operation device according to [14], further including: a voice output unit that outputs a voice, in which, in response to the tactile sensation giving unit giving the tactile sensation at intervals of the predetermined operation amount, the voice output unit outputs a voice corresponding to a type of the given tactile sensation.

[16] It may be the operation device according to [11], in which: the determining unit acquires information representing a point on the touch sensor subjected to the operation, and information representing time of the operation, and derives a speed of the operation on the basis of the point information and the time information, and at intervals of a predetermined operation speed, the tactile sensation giving unit gives a tactile sensation different from the tactile sensation given during start of the operation.

[17] It may be the operation device according to [16], further including: a voice output unit that outputs a voice, in which, in response to the tactile sensation giving unit giving the tactile sensation at intervals of the predetermined operation speed, the voice output unit outputs the voice corresponding to the given tactile sensation.

[18] It may be the operation device according to any one of [11] to [17], in which: in the touch sensor, a first area and another area are determined in advance, such that in response to the first area being operated, a tactile sensation is given, and in response to said another area being operated, any tactile sensation is not given, and in response to the first area being operated, the tactile sensation giving unit gives a first tactile sensation.

[19] It may be the operation device according to [18], in which: in the first area, a second area is determined in advance, such that in response to the second area being operated, a second tactile sensation different from the first tactile sensation is given, and in response to the second area being operated, the tactile sensation giving unit gives the second tactile sensation.

[20] It may be the operation device according to any one of [11] to [19], in which: in a case where the operation on the touch sensor is an operation for adjusting a setting of the operation device or another device, in response to the operation on the touch sensor reaching an upper or lower limit value of a setting range, the tactile sensation giving unit gives a tactile sensation different from the tactile sensation given during the start of the operation, or stops giving the tactile sensation.

According to [1] to [10], the operation device gives the first tactile sensation at intervals of the first operation amount from the operation start point. Therefore, even in a case where the user starts an operation from an arbitrary point, the operation device can give intuitive feedback such that the user can grasp information such as the amount of the operation.

According to [11] to [20], in response to an operation on the touch sensor, the operation device gives a tactile sensation corresponding to the content of the operation. Therefore, the operation device can give intuitive feedback such that the user can grasp information such as the amount of an operation.

### BRIEF DESCRIPTION OF DRAWINGS

FIG. 1 is a view illustrating an outline of an operation device.

FIG. 2 is a view illustrating anther outline of the operation device.

FIG. 3 is a view illustrating an outline of a touch sensor.

FIG. 4 is a view for explaining an operation on the operation device.

FIG. 5 is a view for explaining the operation on the operation device.

FIG. 6 is a view for explaining the operation on the operation device.

FIG. 7 is a flow chart illustrating processing of the operation device.

FIG. 8 is a view illustrating an outline of another operation device.

FIG. 9 is a view for explaining an operation on another operation device.

FIG. 10 is a view for explaining another operation on another operation device.

FIG. 11 is a flow chart illustrating processing of another operation device.

FIG. 12 is a view for explaining an operation on a further operation device.

FIG. 13 is a view illustrating an outline of an operation system.

FIG. 14 is a view illustrating an outline of an operation device.

FIG. 15 is a view illustrating anther outline of the operation device.

FIG. 16 is a view illustrating an outline of a touch sensor.

FIG. 17 is a view for explaining an operation on the operation device.

FIG. 18 is a view for explaining the operation on the operation device.

FIG. 19 is a view for explaining the operation on the operation device.

FIG. 20 is a flow chart illustrating processing of the operation device.

FIG. 21 is a view illustrating an outline of another operation device.

FIG. 22 is a view for explaining an operation on another operation device.

FIG. 23 is a flow chart illustrating processing of another operation device.

### DESCRIPTION OF EMBODIMENTS

Hereinafter, embodiments of the present invention will be described with reference to the accompanying drawings.

### 1. First Embodiment

### 1-1. Configuration of Operation Device

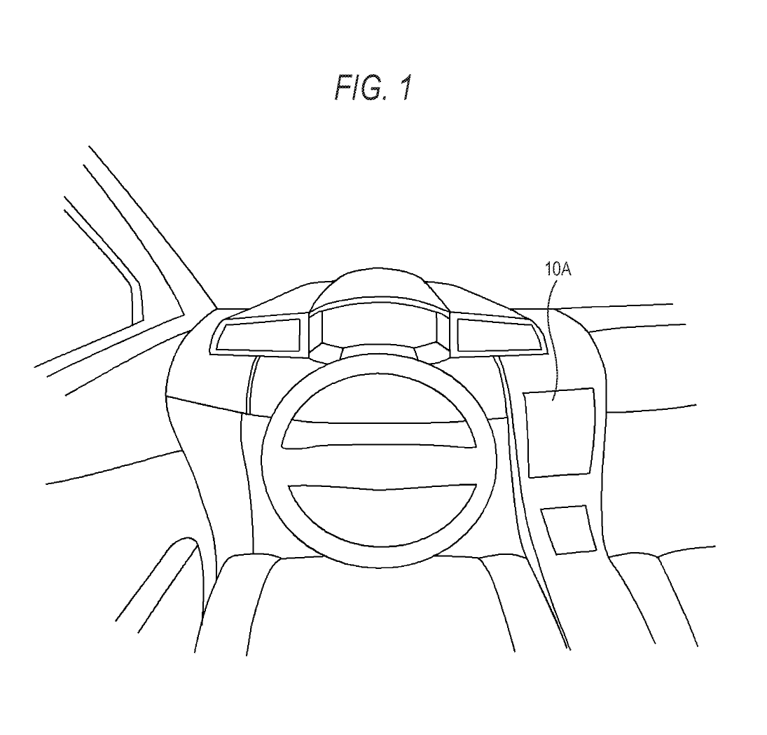

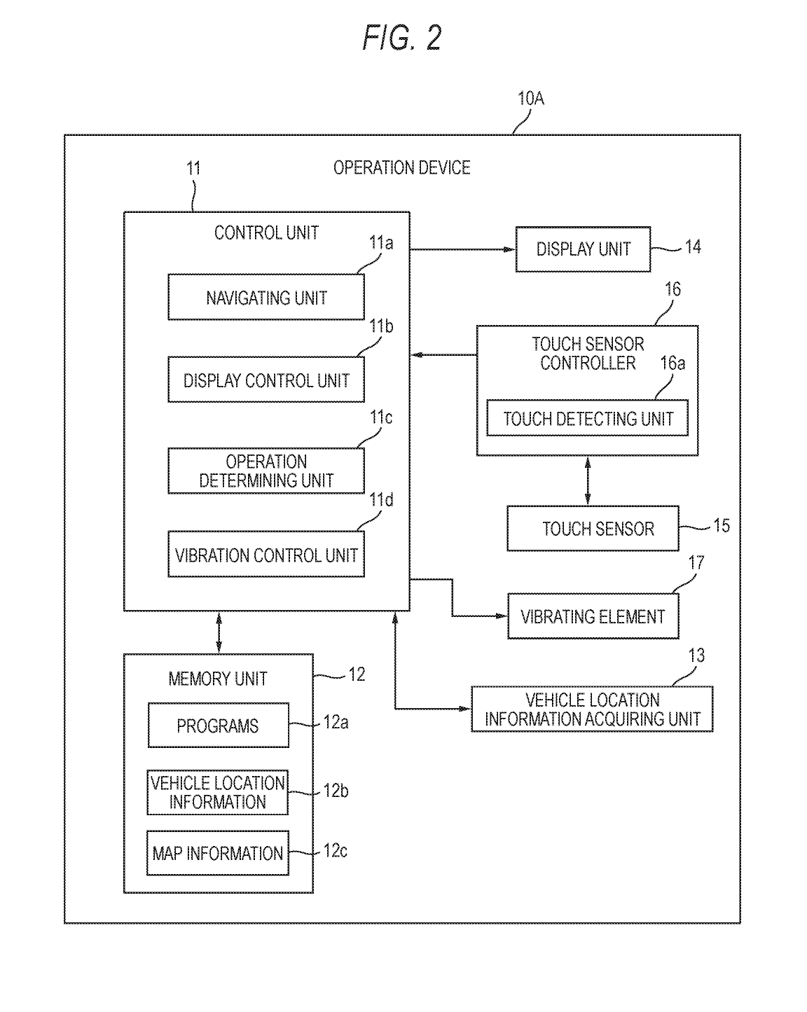

FIGS. 1 and 2 are views illustrating outlines of an operation device 10A according to the present embodiment. The present embodiment will be described with an example in which an operation device 10A is mounted on a vehicle such as an automobile. FIG. 1 is a view illustrating the appearance of the inside of the vehicle equipped with the operation device 10A. FIG. 2 is a view illustrating the outline of the configuration of the operation device 10A.

As shown in FIG. 1, the operation device 10A is an electronic device, which is installed, for example, on the center console of the vehicle, such that a user visibly recognize the operation device, and has at least a display unit and a touch sensor. Also, if the user operates the operation device 10A, the touch sensor vibrates, thereby giving a tactile sensation to the user. Particularly, if the amount of an operation of the user becomes a predetermined amount, the operation device gives a tactile sensation. Therefore, for example, even in a case where the user operates the operation device 10A without seeing the operation device, the operation device can feed the content of the operation such as the operation amount back to the user.

As shown in FIG. 2, the operation device 10A includes a control unit 11, a memory unit 12, a vehicle location information acquiring unit 13, a display unit 14, a touch sensor 15, a touch sensor controller 16, and a plurality of vibrating elements 17.

The control unit 11 is a computer which includes a navigation unit 11a, a display control unit 11b, an operation determining unit 11c, and a vibration control unit 11d, and also includes a CPU, a RAM, and a ROM which are not shown in the drawings. The control unit 11 is connected to other components of the operation device 10A such as the memory unit 12, and performs transmission and reception of information on the basis of programs 12a stored in the memory unit 12, thereby controlling the whole of the operation device 10A. According to the programs 12a stored in the memory unit 12, the CPU performs arithmetic processing, whereby various functions of the control unit 11 including the navigation unit 11a, the display control unit 11b, and the like are implemented.

The navigation unit 11a searches for a route from the current location of the vehicle to a destination, and conducts the vehicle. The navigation unit 11a acquires the current vehicle location information acquired by the vehicle location information acquiring unit 13 and map information 12c retained in the memory unit 12. Then, on the basis of the vehicle location information and the map information, the navigation unit 11a marks the current location of the vehicle on a map of the surrounding area, thereby generating a navigation image. Also, in a case where a destination is set, the navigation unit 11a searches for a route to the destination, and highlights the route to the destination on the navigation image, thereby generating a navigation image.

The display control unit 11b controls the display unit 14 such that the display unit displays the navigation image generated by the navigation unit 11a. Also, the display control unit 11b controls the display unit 14 such that the display unit displays an adjustment screen for changing an adjustment value of a device such as an air conditioner or an audio device.

The operation determining unit 11c determines the content of an operation of the user. Specifically, on the basis of information on a point on the touch sensor 15 (hereinafter, referred to as “operation point information”) subjected to the user's operation, the operation determining unit 11c determines the content of the operation of the user. Also, on the basis of the point information, the operation determining unit 11c derives the amount of the user's operation.

According to the content of the operation of the user determined by the operation determining unit 11c, the vibration control unit 11d controls vibration of the touch sensor 15. Specifically, the vibration control unit 11d controls the vibrating elements 17 according to a variation in the user's operation such that the vibrating elements vibrate. For example, whenever the amount of the user's operation becomes a predetermined amount, the vibration control unit 11d vibrate the vibrating elements 17, thereby vibrating the touch sensor 15. As a result, the user can get a tactile sensation whenever performing the operation by the predetermined amount, thereby capable of recognizing the amount of the user's operation.

The memory unit 12 retains the programs 12a, vehicle location information 12b, and map information 12c. In the present embodiment, the memory unit 12 is a non-volatile memory which can be electrically readable and programmable and whose data is retained when the memory's power is interrupted. As the memory unit 12, for example, an electrical erasable programmable read-only memory (EEPROM) or a flash memory can be used. However, any other memory medium may be used. For example, the memory unit 12 can be composed of a hard disk drive having a magnetic disk.

The programs 12a are so-called system software which the control unit 11 can read and execute in order to control the operation device 10A. The vehicle location information 12b is information representing the location of the vehicle and acquired by the vehicle location information acquiring unit 13. Also, the map information 12c is road information and traffic information on the whole of a country or a certain wide area.

The vehicle location information acquiring unit 13 acquires vehicle location information as information representing the current location of the vehicle. As the vehicle location information acquiring unit 13, for example, a global positioning system (GPS) can be used. Also, the vehicle location information is information including longitude information and latitude information.

The display unit 14 is a display for displaying navigation images and adjustment images, and examples of the display unit include a liquid crystal display and an organic EL (electro luminescence) display.

The touch sensor 15 is a plate-like sensor on which the user performs an input operation. The touch sensor 15 is provided on the screen of the display unit 14 (the user-side surface). That is, the display unit 14 and the touch sensor 15 provided on the screen of the display unit act as a so-called touch panel.

On the screen of the display unit 14, an appropriate command button for receiving an instruction of the user is displayed. The user can touch an area included in the operation surface of the touch sensor 15 and corresponding to the area of the command button with a finger, thereby issuing the instruction associated with the command button to the operation device 10A.

Also, the vibrating elements 17 are disposed so as to be in contact with the touch sensor 15, and are configured so as to vibrate depending on an operation of the user on the touch sensor 15. If the vibrating elements 17 vibrate, the operation surface of the touch sensor 15 also vibrates, thereby giving a tactile sensation to the user.

As the type of the touch sensor 15, for example, an electrostatic capacitance type for perceiving a change in electrostatic capacitance, thereby detecting a point. On the operation surface of the touch sensor 15, the user can perform not only a touch on one point but also a multi-touch which is a touch on a plurality of points.

The touch sensor controller 16 is, for example, a hardware circuit, and controls the operation of the touch sensor 15. The touch sensor controller 16 includes a touch detecting unit 16a, which detects a point on the operation surface of the touch sensor 15 touched by the user, on the basis of a signal generated by the touch sensor 15.

The touch detecting unit 16a detects a point (for example, X and Y coordinates) touched by the user, in a mutual capacitance manner for measuring a change in the electrostatic capacitance between two electrodes, for example, a driving electrode and a reception electrode. The amount of electric charge which the reception electrode receives decreases if the electric field between two electrodes is interrupted by a finger of the user. On the basis of whether the amount of electric charge has decreased, the touch detecting unit 16a detects whether the user has touched or not.

The touch detecting unit 16a can determine whether the user has touched one point or a plurality of points on the operation surface of the touch sensor 15. Then, in a case where the user has touched one point on the operation surface of the touch sensor 15, the touch detecting unit 16a detects the location of that one point. Meanwhile, in a case where the user has touched a plurality of points, the touch detecting unit 16a detects the locations of those points.

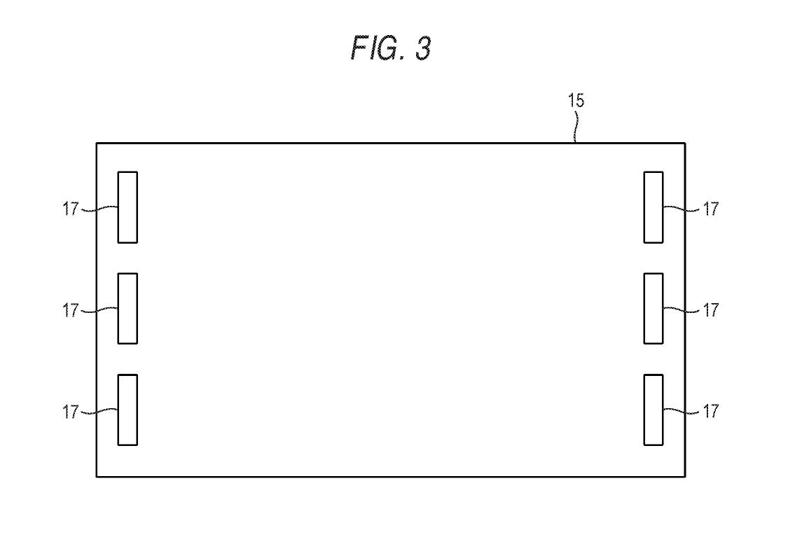

The vibrating elements 17 are members for vibrating the operation surface of the touch sensor 15. More specifically, as shown in FIG. 3, the vibrating elements 17 are disposed on the periphery of the operation surface of the touch sensor 15. These vibrating elements 17 vibrate, thereby vibrating the operation surface of the touch sensor 15. The vibrating elements 17 vibrate under control of the vibration control unit 11d. As the vibrating elements 17, for example, piezoelectric devices such as piezoelectric elements can be used. Also, in the present embodiment, the vibrating elements 17 are lined up along a pair of opposite sides of the touch sensor 15. However, the present invention is not limited thereto. Along an arbitrary side, an arbitrary number of vibrating elements 17 may be disposed.

### 1-2 User's Operation and Process of Causing Feeling

Subsequently, processing which is performed when the user operates the operation device 10A, and a process of causing a tactile sensation at that time will be described. The present embodiment will be described with processing on an operation for adjusting the set temperature of an air conditioner, and a process of causing a tactile sensation during the adjustment operation. Also, in the present invention, “causing a tactile sensation” means vibrating the touch sensor 15, thereby giving a tactile sensation to the user. Also, in the present invention, an adjustment value means a set value (that is, the value of an adjustment target) which is changed in the process during the adjustment operation. The adjustment value is, for example, the set temperature value of the air conditioner.

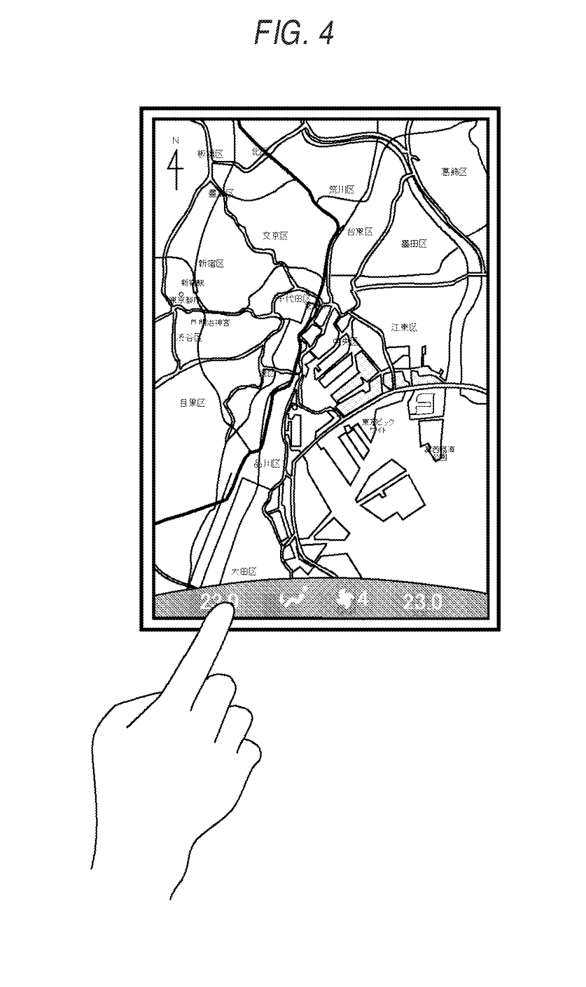

FIG. 4 is a view for explaining a case where the user is operating the touch sensor 15 of the operation device 10A. As shown in FIG. 4, at the lower portion of the display unit 14 of the operation device 10A, the setting state of the air conditioner is displayed. Specifically, the setting state representing the set temperature of 23.0° C., the air flow rate of 4, and other information is displayed.

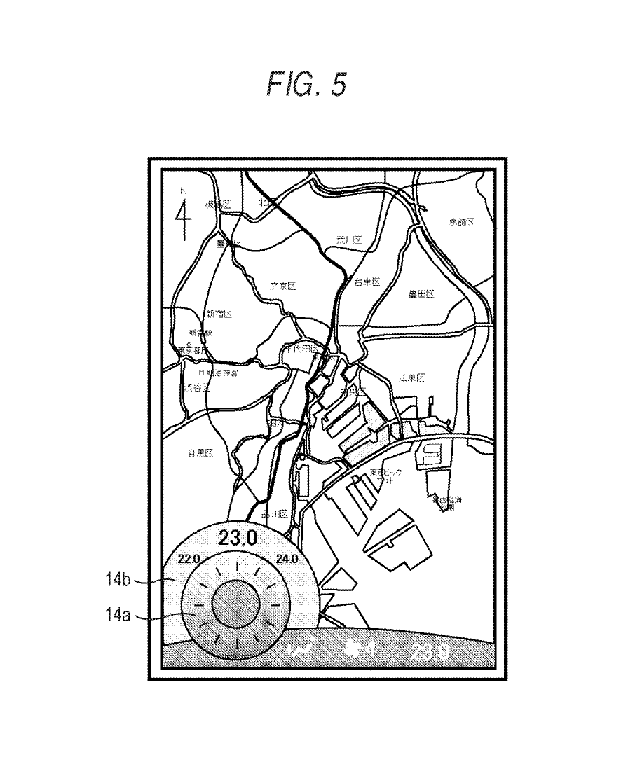

For example, if the user touches a portion of the display unit 14 where the set temperature is displayed (a lower left portion of the display unit 14 where 23.0 is displayed) as shown in FIG. 4, a set temperature adjustment image is displayed as shown in FIG. 5. The adjustment image shown in FIG. 5 includes a circular operation area 14a for adjusting the set temperature, and a circular display area 14b which is disposed outside the operation area and displays adjustment values. Also, in the example of FIG. 5, the whole of the circular operation area 14a is displayed; whereas a partial area of the circular display area 14b is displayed. Further, at the center of the upper portion of the display area 14b, 23.0 which is the current set temperature is displayed, and on the left side and the right side of the circumference, 22.0 and 24.0 which are lower and higher than 23.0 are displayed.

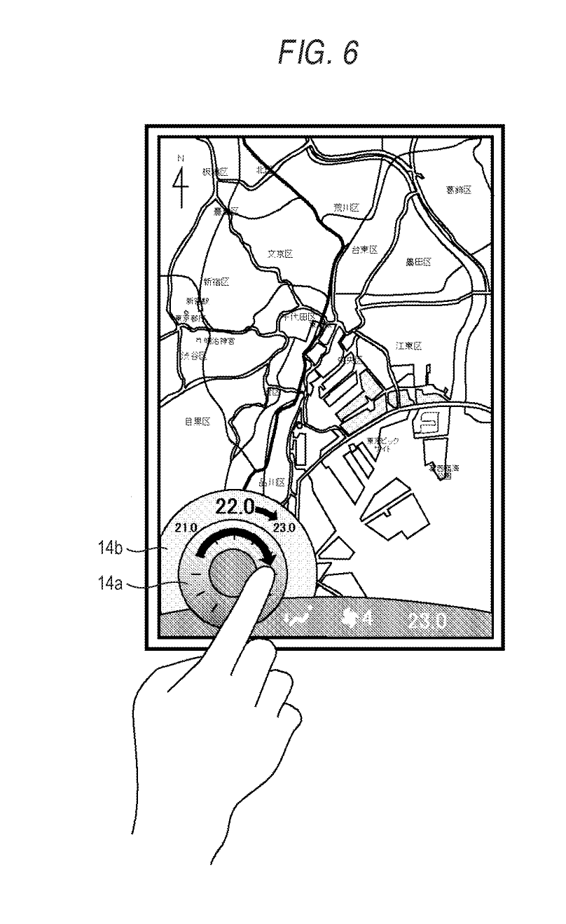

If the user touches the operation area 14a and circularly operates it along the operation area 14a, in response to that operation, the adjustment values of the display area 14b are displayed while rotating. Specifically, as shown in FIG. 6, if the user performs an operation so as to draw a circle on the operation area 14a, in response to the amount of the operation, the set temperature value of the display area 14b moves while rotating. For example, the user touches an arbitrary point of the operation area 14a and performs an operation so as to draw an arc of about 120° (one-third of the circumference) from the touched point. Then, in response to that operation, the display area 14b rotates, and the adjustment value of 23.0 displayed at the center of the upper portion changes to 22.0.

As described above, in the present embodiment, if the user touches an arbitrary point of the operation area 14a for performing an operation such as adjustment of the set temperature, the touched point becomes the current adjustment value, and in response to the amount of the operation from the touched point, the adjustment value can be changed. That is, in a case where points corresponding to individual temperatures have been already determined, in order for temperature adjustment, it is required to touch a point corresponding to the current adjustment value. However, in the present embodiment, even if the user touches any point in the operation area 14a, the point touched for the first time becomes the current adjustment value. Therefore, even in a situation in which the user cannot look at the display unit 14 of the operation device 10A, if the user can touch an arbitrary point on the operation area 14a, the user can change the adjustment value according to the amount of the operation from the touched point.

Also, in the example described above, if the user performs an operation so as to draw an arc of about 120°, the adjustment value charges by 0.1° C. However, the present invention is not limited thereto. The correspondence relation between the amount of the user's operation and variation in the adjustment value can be set arbitrarily and appropriately. That is, the correspondence relation may be set in advance such that the display is changed by the variation corresponding to the amount of the user's operation.

Also, in the present embodiment, whenever the user's operation is performed by a predetermined amount, the operation device gives a tactile sensation. Hereinafter, a method of vibrating the touch sensor 15, thereby producing a tactile sensation, and a process of causing a tactile sensation corresponding to an operation will be described.

In order to produce a tactile sensation, first, the vibration control unit 11d vibrates the vibrating elements 17 at high speed. This high-speed vibration is, for example, ultrasonic vibration. By ultrasonically vibrating the vibrating elements 17, it is possible to ultrasonically vibrate the surface of the touch sensor 15. The vibrating elements 17 disposed along a pair of opposite sides of the touch sensor as shown in FIG. 3 are vibrated, whereby it is possible to substantially uniformly vibrate the entire surface of the touch sensor 15.

If the user operates the surface of the touch sensor 15 with a finger in a state where the surface of the touch sensor 15 ultrasonically vibrates, between the finger and the surface of the touch sensor 15 vibrating at high speed, a high-pressure air membrane is formed, whereby friction resistance decreases. As a result, the user can get a tactile sensation that the finger smoothly slides as compared to a state where the surface of the touch sensor does not vibrate (hereinafter, referred to as a tactile sensation that the surface of the touch sensor is smooth).

Also, if the vibration of the vibrating elements 17 is stopped in a state where the surface of the touch sensor 15 ultrasonically vibrates, the ultrasonic vibration of the surface of the touch sensor 15 also stops. Then, the friction resistance of the surface of the touch sensor 15 returns from the low friction resistance state to the original state (a state where the surface of the touch sensor does not vibrate). That is, the friction resistance changes from the low friction state to the high friction state). In this case, a change from the tactile sensation that the surface of the touch sensor is smooth to a tactile sensation that the finger is caught occurs. When the change from the tactile sensation that the surface of the touch sensor is smooth to the tactile sensation that the finger is caught occurs, the user gets a tactile sensation of clicking. Hereinafter, this tactile sensation of clicking will be referred to as a click tactile sensation.

Also, the vibration intensity of the vibrating elements 17 can be changed, whereby it is possible to ultrasonically vibrate the surface of the touch sensor 15 with a large amplitude or with a small amplitude. In this way, it is possible to repeatedly change the surface of the touch sensor 15 between the high friction state and the low friction state. In other words, the user can alternately get the tactile sensation that the surface of the touch sensor is smooth and the click tactile sensation. In this case, the user can get a tactile sensation that the surface is dimply or a tactile sensation that the surface is rough (hereinafter, referred to collectively as a tactile sensation that the surface of the touch sensor is rough).

Also, the degree of roughness can be changed by changing the intensity of vibration or changing the cycle in which the intensity is changed. Therefore, it is possible to implement a plurality of types of tactile sensations that the surface of the touch sensor is rough, in a stepwise manner, for example, by changing the degree of roughness or changing the frequency of tactile sensations that the surface of the touch sensor is rough.

As described above, the vibrating elements 17 are ultrasonically vibrated, such that the surface of the touch sensor 15 is ultrasonically vibrated, whereby it is possible to give a tactile sensation to the user. Also, by appropriately controlling the start and stop timings, intensity, and the like of ultrasonic vibration, it is possible to change the friction resistance of the surface of the touch sensor. This feature makes it possible to give a variety of tactile sensations.

Also, in the present embodiment, whenever the user's operation is performed by the predetermined amount, the operation device gives a click tactile sensation. For example, whenever the user performs an operation so as to draw an arc of 30° (one-twelfth of the circumference) on the operation area 14a, the operation device gives a click tactile sensation. In this case, when the user performs an operation so as to draw an arc of 120°, the user can get a click tactile sensation four times at intervals of 30°. In other words, even if the user performs the operation without seeing the display unit 14, the user can get a click tactile sensation four times, thereby capable of recognizing that the operation has been performed by 120°. That is, the user can recognize the amount of the operation.

Also, in the above described operation example for adjusting the set temperature, if the upper limit and lower limit of the adjustment value are set to 32.0° C. and 18.0° C., respectively, the amount of the user's operation may exceed the upper limit value or the lower limit value. Therefore, in a case where the operation exceeds the upper limit value or the lower limit value, at a point where the upper limit value or the lower limit value is displayed, a tactile sensation is caused. It is preferable that that tactile sensation should be different from the tactile sensation which is given at intervals of the predetermined amount. If that tactile sensation is given, the user can recognize that the user is performing the operation exceeding the upper limit value or the lower limit value.

Also, in cases where the user performs operations so as to draw arcs, a tactile sensation which is given when the user performs an operation so as to draw an arc in a normal rotation direction (clockwise) may be different from a tactile sensation which is given when the user performs an operation so as to draw an arc in a reverse rotation direction (counterclockwise). In this case, due to those tactile sensations, the user can recognize the directions of the operations.

### 1-3. Processing of Operation Device

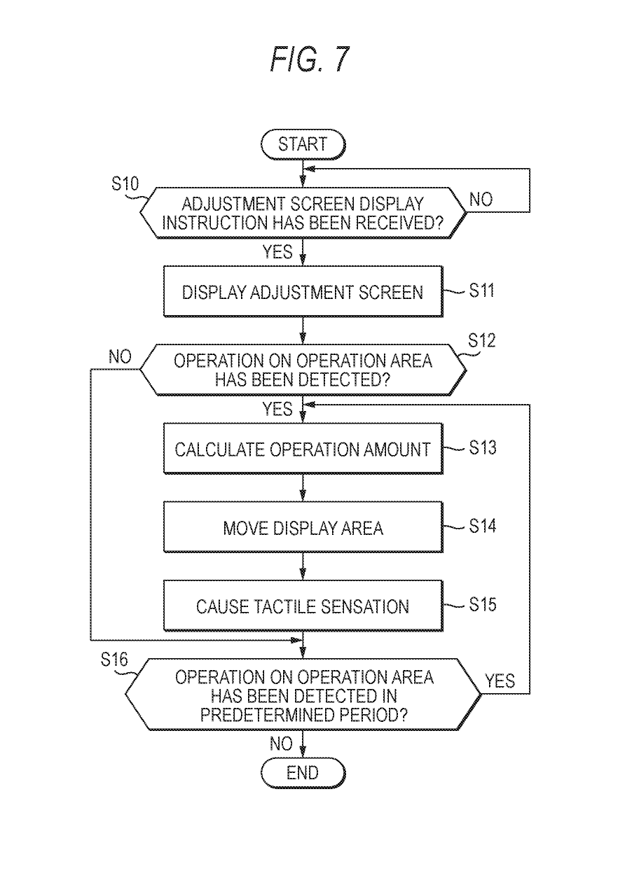

Subsequently, processing of the operation device 10A will be described. FIG. 7 is a flow chart illustrating the processing of the operation device 10A. If the operation device 10A is powered on, thereby being activated, it starts the processing. In STEP S10, the operation device 10A monitors whether an adjustment screen display instruction has been received while being in a standby state until a user's operation is detected. Specifically, the operation device 10A monitors whether the user has touched an area for setting images displayed at the lower portion of the display unit 14, thereby issuing an adjustment screen display instruction.

If the user operates the touch sensor 15, the operation device 10A acquires point information (for example, an X coordinate and a Y coordinate), and determines the point operated by the user, and the content of the operation. In a case where it is determined that the user's operation is a predetermined operation, the operation device determines that an adjustment screen display instruction has been received. Examples of the predetermined operation include flicking up. That is, on the basis of the X coordinate and the Y coordinate touched by the user, the operation device 10A determines that the point touched by the user is in the setting image area. Thereafter, if the X coordinate and the Y coordinate change, the operation device determines that flicking up has been detected. In this case, the operation device determines that an adjustment screen display instruction has been received.

In a case where any adjustment screen display instruction has not been received (“No” in STEP S10), the operation device 10A monitors whether an adjustment screen display instruction has been received, again. Meanwhile, in a case where an adjustment screen display instruction has been received (“Yes” in STEP S10), in STEP S11, the operation device 10A displays an adjustment screen. Specifically, the operation device 10A displays an adjustment screen related to a setting mage touched by the user. In other words, in a case where the user touches a set temperature display image and flicks up, a temperature setting adjustment screen is displayed.

Subsequently, in STEP S12, the operation device 10A determines whether an operation on the operation area 14a has been detected. Even in this process, the operation device 10A acquires the point information (the X coordinate and the Y coordinate) acquired during the start of the user's operation on the touch sensor 15, and determines the point operated by the user, and the content of the operation, thereby determining whether an operation on the operation area 14a has been detected.

In a case where an operation on the operation area 14a has been detected (“Yes” in STEP S12), in STEP S13, the operation device 10A derives the amount of the operation. In other words, the operation device 10A derives the amount (distance) of the user's operation on the operation area 14a. This operation amount is derived on the basis of the point information (the X coordinate and the Y coordinate) acquired.

In this process of deriving the amount of the operation, the trajectory of the operation is also derived. For example, in a case where the user has performed an operation so as to draw an arc, the operation device derives whether the operation has been performed in the normal rotation direction (clockwise) or in the reverse rotation direction (counterclockwise).

Subsequently, in STEP S14, the operation device 10A displays while moving the display area 14b. That is, the operation device 10A moves the display area 14b on the basis of the amount of the operation, and displays the display area 14b. That is, the adjustment value displayed in the display area 14b moves. Also, as described above, the movement amount of the adjustment value is determined on the basis of the preset correspondence relation between the amount of the operation and the movement amount. Also, in a case where the user has performed an operation so as to draw an arc, display moves in the same direction as the rotation direction of the operation.

Subsequently, in STEP S15, the operation device 10A causes a tactile sensation. That is, the operation device 10A produces a tactile sensation whenever the amount of the user's operation becomes the predetermined amount. Specifically, whenever the operation device 10A determines that the operation has been performed by the predetermined amount, it vibrates the vibrating elements 17. As a result, the touch sensor 15 vibrates, thereby capable of causing a tactile sensation. Also, in a case where the user has performed an operation so as to draw an arc, the operation device causes a tactile sensation depending on the rotation direction. That is, the operation device 10A changes the vibration state of the vibrating elements 17 depending on whether the corresponding operation has been performed in the normal rotation direction or in the reverse rotation direction.

Subsequently, in STEP S16, the operation device 10A determines whether an operation on the operation area 14a has been detected in a predetermined period. In a case where the user has operated the operation area in the predetermined period (“YES” in STEP S16), the operation device performs the operation amount deriving process with respect to the detected operation again. Meanwhile, in a case where the user has not operated the operation area in the predetermined period (“NO” in STEP S16), the operation device 10A determines that the adjustment operation has finished. If the adjustment operation finishes, the operation device determines the adjustment value displayed at that moment, as the changed value.

As described above, in a case where an operation on the operation area 14a has been detected, on the basis of the operation amount from the touched point, the operation device derives the adjustment value movement amount (change amount) from the current adjustment value. Therefore, if the user touches an arbitrary point of the operation area 14a, the user can perform an operation. That is, if the user can touch a point in the operation area 14a without looking at the display unit 14, it becomes possible to perform an operation. Also, since a tactile sensation is caused whenever an operation of the predetermined amount is detected, even if the user keeps operating without seeing the display unit 14, the user can recognize the amount of the operation.

### 2. Second Embodiment

Subsequently, a second embodiment will be described. In the first embodiment described above, a point of the operation area 14a which is touched by the user becomes the current adjustment value, and an adjustment operation from the current adjustment value is performed. However, the present invention is not limited thereto. For example, each adjustment value may be associated with a certain point of the operation area 14a in advance, such that the user can touch a point and perform an adjustment operation from the adjustment value associated with the touched point. Hereinafter, differences from the first embodiment will be mainly described.

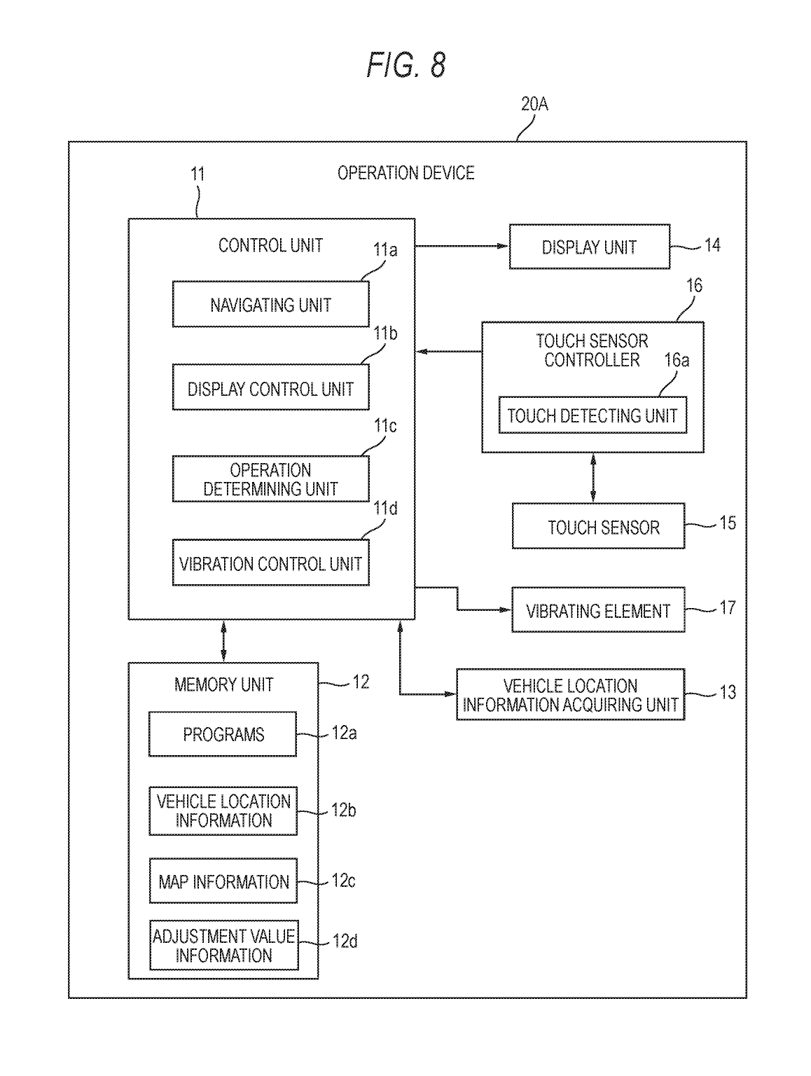

First, the configuration of an operation device 20A according to the present embodiment will be described. FIG. 8 is a view illustrating the outline of the configuration of the operation device 20A. As shown in FIG. 8, the operation device 20A of the present embodiment is different from the operation device 10A described in the first embodiment in that the memory unit 12 retains adjustment value information 12d. The other configuration of the operation device 20A is identical to that of the operation device 10A.

The adjustment value information 12d is information including adjustment values which the user uses to perform an adjustment operation and points of the operation area 14a associated with the adjustment values. For example, in a case of a temperature setting adjustment operation, points dividing the operation area 14a into twelve portions are associated with adjustment values of 18.0° C. to 29.0° C., respectively, whereby the adjustment value information 12d is generated. More specifically, the center point of the upper portion is associated with 18.0° C., and points positioned at intervals of 30° clockwise from the center point of the upper portion are associated with 19.0° C. and 20.0° C. In this case, a point positioned at 240° from the center point of the upper portion (from the point associated with 18.0° C.) is associated with 26.0° C.

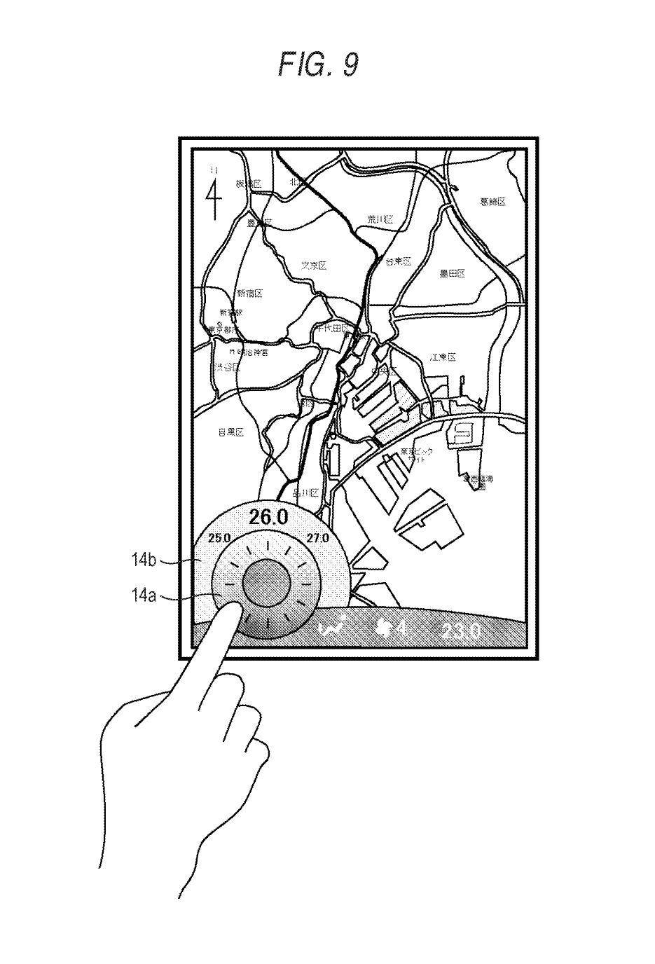

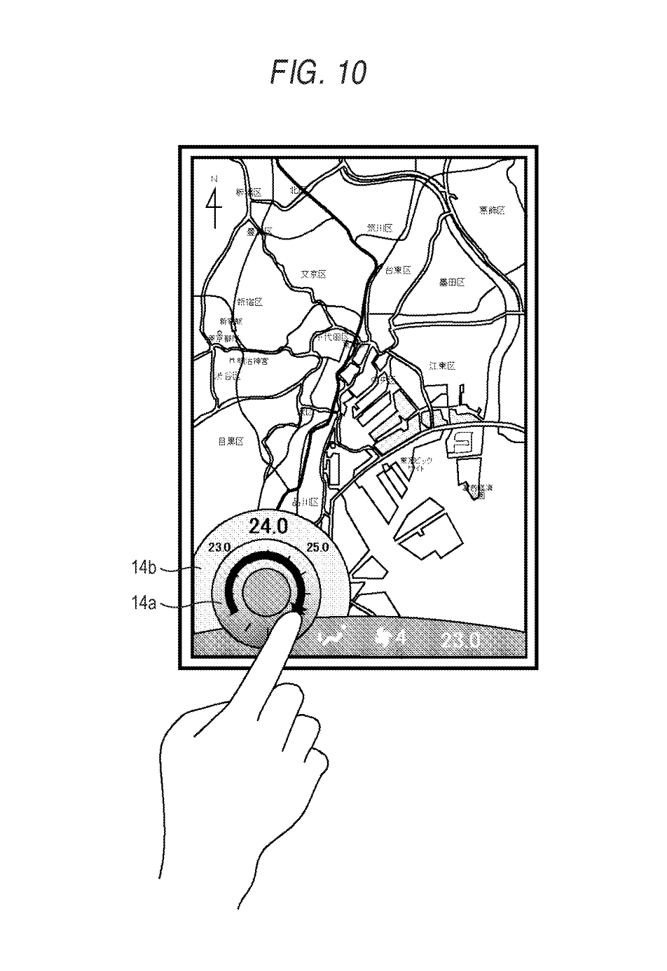

A method of performing an adjustment operation using the adjustment value information 12d will be described. FIGS. 9 and 10 are views for explaining a case where the user operates the touch sensor 15 of the operation device 20A. As shown in FIG. 9, if the user touches the point positioned at 240° C., 26.0° C. is displayed as the adjustment value of the adjustment screen. Even in a case where the current adjustment value is 23.0° C., an adjustment value associated with a point touched by the user is displayed.

Thereafter, similarly in the first embodiment, in response to the amount of the user's operation, the display area 14b rotates, whereby the displayed adjustment value changes. Specifically, for example, in a case where the adjustment value changes by 1.0° C. if the user draws an arc of about 120°, as shown in FIG. 10, if the user draws an arc of 240°, the adjustment values rotate by 2.0° C., whereby 24.0° C. is displayed at the center of the upper portion.

In the first embodiment, regardless of the point touched by the user, from the current adjustment value, an adjustment operation based on the amount of the user's operation is performed. However, as described above, in the present embodiment, from the adjustment value associated with the point touched by the user, an adjustment operation based on the amount of the user's operation is performed.

Therefore, in the first embodiment, in a case where the current adjustment value is 23.0° C., if the user touches an arbitrary point of the operation area 14a, an adjustment operation from 23.0° C. becomes possible. In contrast to this, in the present embodiment, even in the case where the current adjustment value is 23.0° C., if a point touched by the user is associated with 26.0° C., an adjustment operation from 26.0° C. becomes possible.

Also, the number, intervals, and the like of adjustment values to be associated in advance can be appropriately set. For example, points dividing the operation area 14a into twenty four portions, not twelve portions may be associated with twenty four values, respectively. Also, the center point of the upper portion (a point positioned at) 0° may be associated with, for example, 23.0° C., not 18.0° C.

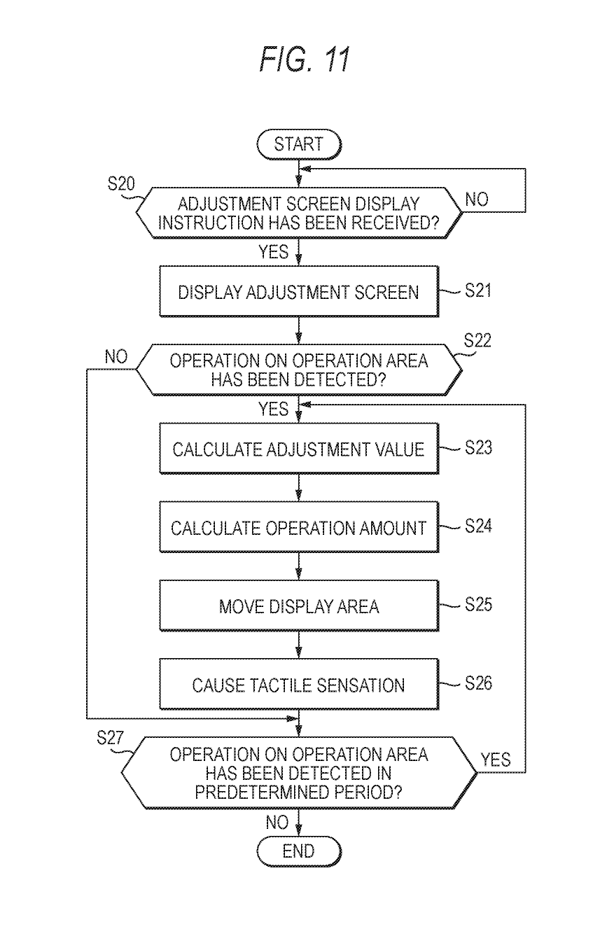

Subsequently, processing of the operation device 20A will be described. FIG. 11 is a flow chart illustrating the processing of the operation device 20A according to the present embodiment. As shown in FIG. 11, the operation device 20A performs a process of monitoring an adjustment screen display instruction (STEP S20), an adjustment screen display process (STEP S21), and a process of monitoring whether an operation on the operation area has been detected (STEP S22). These processes are identical to the processes of STEPS S10 to S12 of the first embodiment.

Then, in a case of determining that an operation on the operation area 14a has been detected, in STEP S23, the operation device 20A derives an adjustment value. That is, on the basis of point information acquired during the start of the user's operation on the operation area 14a and the adjustment value information 12d retained in the memory unit 12, the operation device 20A derives an adjustment value associated with the point touched by the user. Subsequently, the operation device 20A displays the derived adjustment value as an adjustment start value at the center of the upper portion.

Subsequently, the operation device 20A performs an operation amount deriving process (STEP S24), a display area moving process (STEP S25), a tactile sensation causing process (STEP S26), and a process of monitoring whether a period when any operation has not been detected is the predetermined period (STEP S27). These processes are identical to the processes of STEPS S13 to S16 of the first embodiment.

As described above, in a case where an operation on the operation area 14a has been detected, from an adjustment value corresponding to the touched point, the operation device derives an adjustment value movement amount on the basis of the amount of the operation from the touched point. Therefore, in a case where the user touches an arbitrary point of the operation area 14a, from an adjustment value displayed at that moment, the user can perform an operation. Also, since a tactile sensation is caused whenever an operation of the predetermined amount is detected, even if the user keeps operating without seeing the display unit 14, the user can recognize the amount of the operation.

### 3. Modifications

Although the first and second embodiments of the present invention have been described above, the present invention is not limited to the embodiments, and can be modified in various forms. Hereinafter, these modifications will be described. All forms including the embodiments described above and the following forms to be described below can be appropriately combined.

### 3-1. First Modification

In each embodiment described above, whenever the user's operation is performed by the predetermined amount, the operation device gives a tactile sensation. However, the present invention is not limited thereto. It is possible to add a variety of tactile sensations.

For example, in addition to the configuration in which the operation device gives a tactile sensation at intervals of the predetermined amount, the operation device may give a different tactile sensation when the adjustment value reaches a specific adjustment value. The specific adjustment value is, for example, a median adjustment value (such as the median of a temperature setting range, the median of a sound volume setting range, or an equal valance point of adjustment of the balance between the volume of left sound and the volume of right sound in stereo reproduction). Also, examples of the different tactile sensation include consecutively giving a click tactile sensation twice (a double-click tactile sensation). As a result, the user can recognize not only the amount of the operation but also that the adjustment value has reached the median adjustment value.

In each embodiment described above, at intervals of a first predetermined operation amount from the operation start point, a first tactile sensation is given. However, in the present modification, at intervals of a second predetermined operation amount different from the first predetermined operation amount, a second tactile sensation different from the first tactile sensation is given.

Also, in each embodiment described above, the predetermined amount for giving a tactile sensation is 30°. However, the present invention is not limited thereto. Any other appropriate amount such as 10° or 15° can be set. Also, the interval at which a tactile sensation is given may be changed according to the number of operation steps. For example, a first tactile sensation may be given at 30°, and a second tactile sensation may be given at 60°. Also, the interval at which a tactile sensation is given may be changed depending on the adjustment targets. For example, a predetermined amount for temperature adjustment and a predetermined amount for air flow rate adjustment may be different from each other. Also, while a tactile sensation is given, an effect sound may be output. In this case, it is preferable that the effect sound should depend on each tactile sensation.

Also, in each embodiment described above, in the operation example for adjusting the set temperature, when the operation exceeds the upper limit or the lower limit, a tactile sensation is caused at the point where the upper limit or the lower limit is displayed. However, the present invention is not limited thereto. As described above, at the moment when the operation exceeds the upper limit or the lower limit, a tactile sensation can be caused. Alternatively, after the operation exceeds the upper limit or the lower limit, a tactile sensation may be caused for a predetermined period. Also, while the operation exceeds the upper limit or the lower limit, a tactile sensation is caused. In every case, the user can recognize that the user is performing an operation exceeding the upper limit or the lower limit.

### 3-2. Second Modification

In the second embodiment described above, from an adjustment value associated with a point touched by the user, an adjustment operation is performed. However, the present invention is not limited thereto. In order to set an adjustment value as the start point for adjustment, any other method may be used.

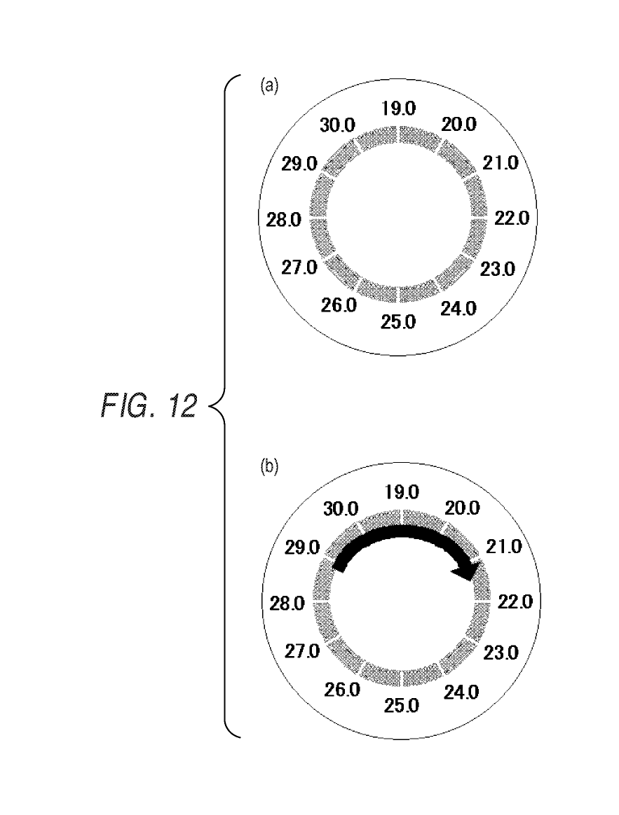

For example, there is a method of associating a plurality of points of a specific shape with adjustment values and deriving a point of the specific shape corresponding to the trajectory of a user's operation, and setting the derived point as the start point. Specifically, in the present modification, adjustment value information including a plurality of points at the periphery of a circle and adjustment values associated with each other as shown in (a) of FIG. 12 are stored. For example, an adjustment value at the point of 0 o'clock is set to 19° C., and points positioned at intervals of 30° C. clockwise are associated with adjustment values higher than 19° C. and taken at intervals of 1° C.

In this case, for example, if the user performs an operation so as to draw an arbitrary arc from an arbitrary point of an operable area of the operation device, the operation device derives a point where the shape of the arc and the circle shape of the adjustment value information correspond to each other. Specifically, in a case where the user performs an operation as shown in FIG. 6, the operation device derives a point where the trajectory of the user's operation coincides with the periphery of the circle as shown in (b) of FIG. 12. Then, the operation device sets the adjustment value of the derived point on the periphery of the circle as the value of the start point. In the example of (b) of FIG. 12, the value of the start point becomes 29.0° C.

As described above, the present modification is the method of deriving a point where the trajectory of a user's operation and a shape which is used as adjustment value information correspond to each other, and setting an adjustment value corresponding to the start point of the user's operation as the start point. Therefore, even though the user starts an operation from an arbitrary point, if the user operates a portion of a shape which is used as the adjustment value information, it becomes possible to set the start point of the adjustment value on the basis of the trajectory of the user's operation, and thus it is possible to set a desired adjustment value.

### 3-3. Third Modification

Also, in each embodiment described above, the integrated electronic device obtained by provided the touch sensor on the display unit is operated. However, the present invention is not limited thereto. The display unit and the touch sensor may be separate electronic devices. In this case, the operation device becomes an operation system which can be remotely operated. That is, an operation is performed on the touch sensor, and display is performed on the separate display unit.

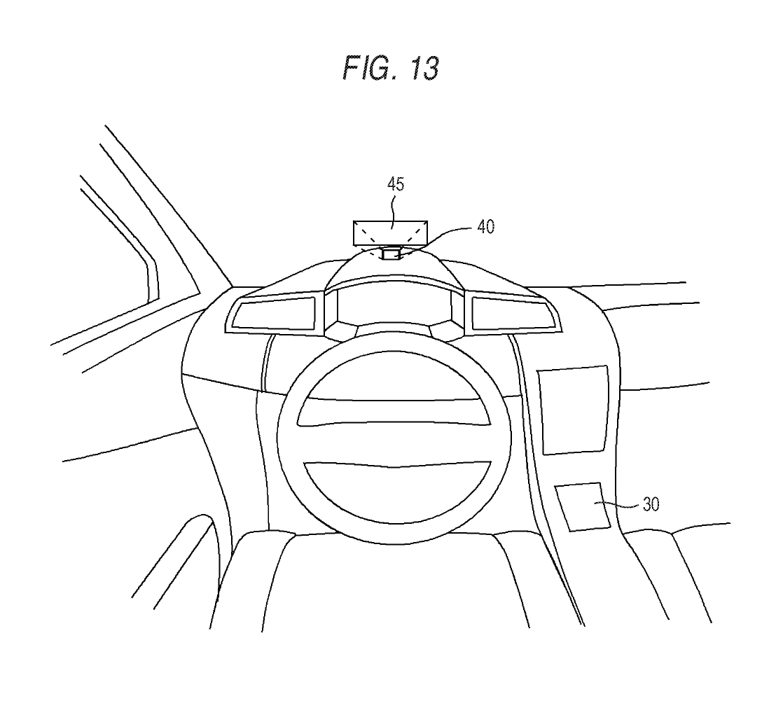

FIG. 13 is a view illustrating the outline of the operation system according to the present modification. As shown in FIG. 13, in the present modification, a remote operation device 30 having a touch sensor is provided on the center console of a vehicle so as to be within the reach of the user's hands, and a display device 40 for projecting an image to a portion of front glass positioned substantially in front of the user is provided on the dashboard. The remote operation device 30 is a so-called touch pad having no display unit, and the display device 40 is, for example, a head up display.

The remote operation device 30 and the display device 40 operate in cooperation with each other, and the user operates the remote operation device 30 at hand while seeing a screen 45 projected by the display device 40. In other words, it is possible to perform a remote operation (a so-called blind operation) without seeing a hand performing the operation.

Therefore, similarly to each embodiment described above, by operating a point on the touch sensor of the remote operation device 30 corresponding to the operation area of the screen 45 projected by the display unit 14, an operation similar to that on the integrated operation device in each embodiment described above becomes possible. In other words, in the present modification, since the remote operation device 30 and the display device 40 are provided at different positions, and each operation point of the remote operation device 30 is associated with a point in the screen 45 which is projected by the display device 40, if the user operates the remote operation device 30 at hand while seeing the front screen 45, an adjustment operation like that in each embodiment described above becomes possible.

Also, in a case of operating the touch sensor as in the present modification, not only a configuration for operating a circular operation area as in each embodiment described above but also a configuration for operating an arbitrary point can be applied. In this case, regardless of an operation gesture (such as a circle), on the basis of the amount of an operation (the distance of the operation) and the direction of the operation, the adjustment value may be changed.

Also, in each above described embodiment, various functions are implemented in a software wise by arithmetic processing of the CPU according to programs. However, some of those functions may be implemented by electric hardware circuits. Also, conversely, some of functions which are implemented by hardware circuits may be implemented in a software wise.

### 4. Third Embodiment

### 4-1. Configuration of Operation Device

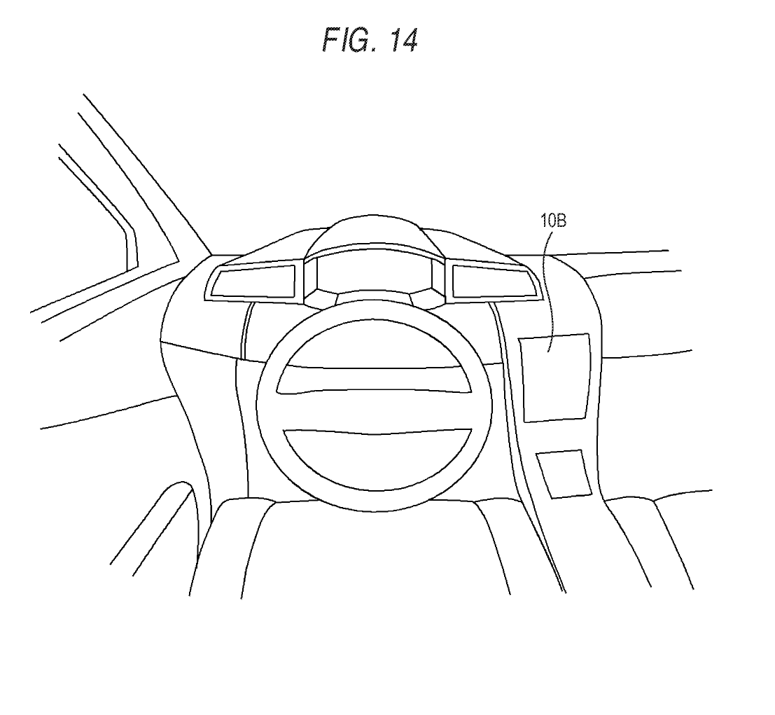

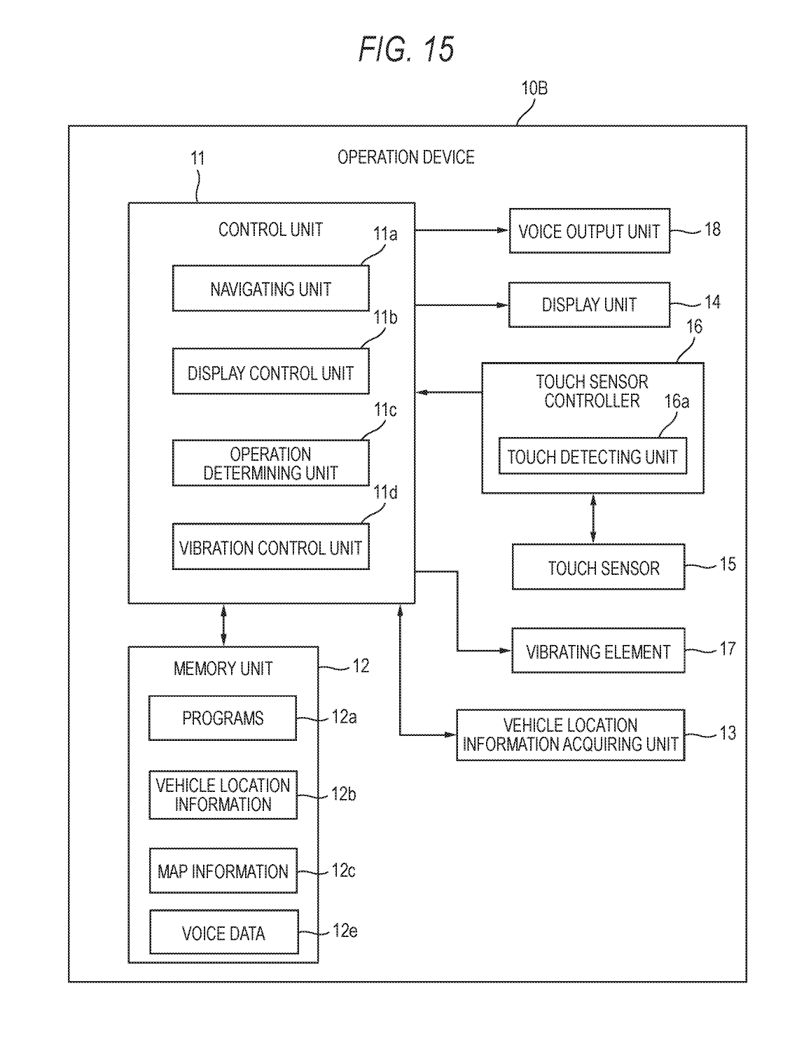

FIGS. 14 and 15 are views illustrating outlines of an operation device 10B according to the present embodiment. The present embodiment will be described with an example in which an operation device 10B is mounted on a vehicle such as an automobile. FIG. 14 is a view illustrating the appearance of the inside of the vehicle equipped with the operation device 10B. FIG. 15 is a view illustrating the outline of the configuration of the operation device 10B.

As shown in FIG. 14, the operation device 10B is an electronic device, which is installed, for example, on the center console of the vehicle, such that a user visibly recognize the operation device, and has at least a display unit and a touch sensor. Also, if the user operates the operation device 10B, the touch sensor vibrates, thereby giving a tactile sensation to the user. Therefore, the operation device can give intuitive feedback on the content of an operation to the user.

As shown in FIG. 15, the operation device 10B includes a control unit 11, a memory unit 12, a vehicle location information acquiring unit 13, a display unit 14, a touch sensor 15, a touch sensor controller 16, a plurality of vibrating elements 17, and a voice output unit 18.

The control unit 11 is a computer which includes a navigation unit 11a, a display control unit 11b, an operation determining unit 11c, and a vibration control unit 11d, and a CPU, a RAM, and a ROM which are not shown in the drawings. The control unit 11 is connected to other components of the operation device 10B such as the memory unit 12, and performs transmission and reception of information on the basis of programs 12a stored in the memory unit 12, thereby controlling the whole of the operation device 10B. According to the programs 12a stored in the memory unit 12, the CPU performs arithmetic processing, whereby various functions of the control unit 11 including the navigation unit 11a and the display control unit 11b are implemented.

The navigation unit 11a searches for a route from the current location of the vehicle to a destination, and conducts the vehicle. The navigation unit 11a acquires the current vehicle location information acquired by the vehicle location information acquiring unit 13 and map information 12c retained in the memory unit 12. Then, on the basis of the vehicle location information and the map information, the navigation unit 11a marks the current location of the vehicle on a map of the surrounding area, thereby generating a navigation image. Also, in a case where a destination is set, the navigation unit 11a searches for a route to the destination, and highlights the route to the destination on the navigation image, thereby generating a navigation image.

The display control unit 11b performs control such that the display unit 14 displays a map image or a navigation image. Also, the display control unit 11b performs control such that the display unit 14 displays an adjustment screen for adjusting a set value of a device such as an air conditioner or an audio device.

The operation determining unit 11c determines the content of an operation of the user. Specifically, on the basis of point information and time information acquired during the start of the user's operation on the touch sensor 15, the operation determining unit 11c determines the content of the operation of the user. Also, on the basis of the point information, the operation determining unit 11c derives the amount of the user's operation.

Further, on the basis of the point information and the time information acquired during the start of the user's operation on the touch sensor 15, the operation determining unit 11c determines the content of the user's operation. In the present embodiment, examples of the content of the operation include swiping, flicking, and pinching in/out. Swiping is dragging a finger right, left, up, or down on the touch sensor. Also, flicking is hitting the touch sensor with a quick motion of a finger. Also, pinching in/out is narrowing or widening the distance between two fingers being in contact with the touch sensor.

According to the content of the operation of the user determined by the operation determining unit 11c, the vibration control unit 11d controls vibration of the touch sensor 15. Specifically, for example, if it is determined that the user has started flicking or pinching in/out, the vibration control unit 11d performs control such that the vibrating elements 17 vibrate. As a result, the user can get a tactile sensation during the operation, thereby getting intuitive feedback on the content of the operation.

The memory unit 12 retains the programs 12a, vehicle location information 12b, map information 12c, and voice data 12e. In the present embodiment, the memory unit 12 is a non-volatile memory which can be electrically readable and programmable and whose data is retained when the memory's power is interrupted. As the memory unit 12, for example, an electrical erasable programmable read-only memory (EEPROM) or a flash memory can be used. However, any other memory medium may be used. For example, the memory unit 12 can be composed of a hard disk drive having a magnetic disk.

The programs 12a are so-called system software which the control unit 11 can read and execute in order to control the operation device 10B. The vehicle location information 12b is information representing the location of the vehicle and acquired by the vehicle location information acquiring unit 13. Also, the map information 12c is road information and traffic information on the whole of a country or a certain wide area.

Also, the voice data 12e is data related to effect sounds associated with the contents of operations. For example, in a case where the operation device is configured so as to output a specific effect sound (for example, a sound “shuk”) if the user performs flicking, information including the corresponding operation content and data on the sound “shuk” associated with each other is included in the voice data 12e.

The vehicle location information acquiring unit 13 acquires vehicle location information as information representing the current location of the vehicle. As the vehicle location information acquiring unit 13, for example, a global positioning system (GPS) can be used. Also, the vehicle location information is information including longitude information and latitude information.

The display unit 14 is a display for displaying navigation images and adjustment images, and examples of the display unit include a liquid crystal display and an organic EL (electro luminescence) display.

The touch sensor 15 is a plate-like sensor on which the user performs an input operation. The touch sensor 15 is provided on the screen of the display unit 14 (the user-side surface). That is, the display unit 14 and the touch sensor 15 provided on the screen of the display unit act as a so-called touch panel.

On the screen of the display unit 14, an appropriate command button for receiving an instruction of the user is displayed. The user can touch an area included in the operation surface of the touch sensor 15 and corresponding to the area of the command button with a finger, thereby issuing the instruction associated with the command button to the operation device 10B.

Also, the vibrating elements 17 are disposed so as to be in contact with the touch sensor 15, and are configured so as to vibrate depending on an operation of the user on the touch sensor 15. If the vibrating elements 17 vibrate, the operation surface of the touch sensor 15 also vibrates, thereby giving a tactile sensation to the user.

As the type of the touch sensor 15, for example, an electrostatic capacitance type for perceiving a change in electrostatic capacitance, thereby detecting a point. On the operation surface of the touch sensor 15, the user can perform not only a touch on one point but also a multi-touch which is a touch on a plurality of points.

The touch sensor controller 16 is, for example, a hardware circuit, and controls the operation of the touch sensor 15. The touch sensor controller 16 includes a touch detecting unit 16a, which detects a point on the operation surface of the touch sensor 15 touched by the user, on the basis of a signal generated by the touch sensor 15.

The touch detecting unit 16a detects a point (for example, X and Y coordinates) touched by the user, in a mutual capacitance manner for measuring a change in the electrostatic capacitance between two electrodes, for example, a driving electrode and a reception electrode. The amount of electric charge which the reception electrode receives decreases if the electric field between two electrodes is interrupted by a finger of the user. On the basis of whether the amount of electric charge has decreased, the touch detecting unit 16a detects whether the user has touched or not.

The touch detecting unit 16a can determine whether the user has touched one point or a plurality of points on the operation surface of the touch sensor 15. Then, in a case where the user has touched one point on the operation surface of the touch sensor 15, the touch detecting unit 16a detects the location of that one point. Meanwhile, in a case where the user has touched a plurality of points, the touch detecting unit 16a detects the locations of those points.

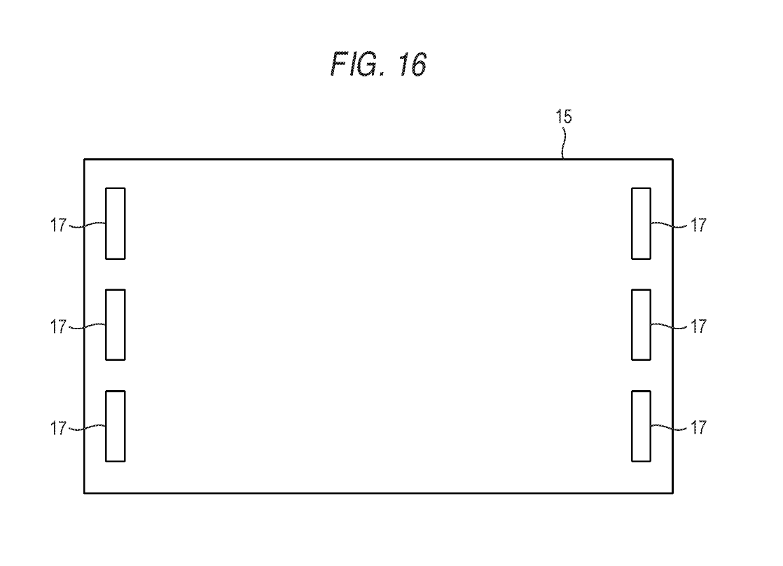

The vibrating elements 17 are members for vibrating the operation surface of the touch sensor 15. More specifically, as shown in FIG. 16, the vibrating elements 17 are disposed on the periphery of the operation surface of the touch sensor 15. These vibrating elements 17 vibrate, thereby vibrating the operation surface of the touch sensor 15. The vibrating elements 17 vibrate under control of the vibration control unit 11d. As the vibrating elements 17, for example, piezoelectric devices such as piezoelectric elements can be used. Also, in the present embodiment, the vibrating elements 17 are lined up along a pair of opposite sides of the touch sensor 15. However, the present invention is not limited thereto. Along an arbitrary side, an arbitrary number of vibrating elements 17 may be disposed.

The voice output unit 18 is a speaker for outputting the voice data to the outside. The voice output unit 18 outputs voice data on an effect sound corresponding to the content of a user's operation.

### 4-2 User's Operation and Process of Causing Tactile Sensation

Subsequently, processing which is performed when the user operates the operation device 10B, and a process of causing a tactile sensation at that time will be described. Also, in the present invention, “causing a tactile sensation” means vibrating the touch sensor 15, thereby giving a tactile sensation to the user.

In the present embodiment, first, a method of vibrating the touch sensor 15, thereby producing a tactile sensation, and the types of tactile sensations will be described.

In order to produce a tactile sensation, first, the vibration control unit 11d vibrates the vibrating elements 17 at high speed. This high-speed vibration is, for example, ultrasonic vibration. By ultrasonically vibrating the vibrating elements 17, it is possible to ultrasonically vibrate the surface of the touch sensor 15. The vibrating elements 17 disposed along a pair of opposite sides of the touch sensor as shown in FIG. 16 are vibrated, whereby it is possible to substantially uniformly vibrate the entire surface of the touch sensor 15.

If the user operates the surface of the touch sensor 15 with a finger in a state where the surface of the touch sensor 15 ultrasonically vibrates, between the finger and the surface of the touch sensor 15 vibrating at high speed, a high-pressure air membrane is formed, whereby friction resistance decreases. As a result, the user can get a tactile sensation that the finger smoothly slides as compared to a state where the surface of the touch sensor does not vibrate (hereinafter, referred to as a tactile sensation that the surface of the touch sensor is smooth).

Also, if the vibration of the vibrating elements 17 is stopped in a state where the surface of the touch sensor 15 ultrasonically vibrates, the ultrasonic vibration of the surface of the touch sensor 15 also stops. Then, the friction resistance of the surface of the touch sensor 15 returns from the low friction resistance state to the original state (a state where the surface of the touch sensor does not vibrate). That is, the friction resistance changes from the low friction state to the high friction state). In this case, a change from the tactile sensation that the surface of the touch sensor is smooth to a tactile sensation that the finger is caught occurs. When the change from the tactile sensation that the surface of the touch sensor is smooth to the tactile sensation that the finger is caught occurs, the user gets a tactile sensation of clicking. Hereinafter, this tactile sensation of clicking will be referred to as a click tactile sensation.

Also, the vibration intensity of the vibrating elements 17 can be changed, whereby it is possible to ultrasonically vibrate the surface of the touch sensor 15 with a large amplitude or with a small amplitude. In this way, it is possible to repeatedly change the surface of the touch sensor 15 between the high friction state and the low friction state. In other words, the user can alternately get the tactile sensation that the surface of the touch sensor is smooth and the click tactile sensation. In this case, the user can get a tactile sensation that the surface is dimply or a tactile sensation that the surface is rough (hereinafter, referred to collectively as a tactile sensation that the surface of the touch sensor is rough).

Also, the degree of roughness can be changed by changing the intensity of vibration or changing the cycle in which the intensity is changed. Therefore, it is possible to implement a plurality of types of tactile sensations that the surface of the touch sensor is rough, in a stepwise manner, for example, by changing the degree of roughness or changing the frequency of tactile sensations that the surface of the touch sensor is rough.

As described above, the vibrating elements 17 are ultrasonically vibrated, such that the surface of the touch sensor 15 is ultrasonically vibrated, whereby it is possible to give a tactile sensation to the user. Also, by appropriately controlling the start and stop timings, intensity, and the like of ultrasonic vibration, it is possible to change the friction resistance of the surface of the touch sensor. This feature makes it possible to give a variety of tactile sensations.

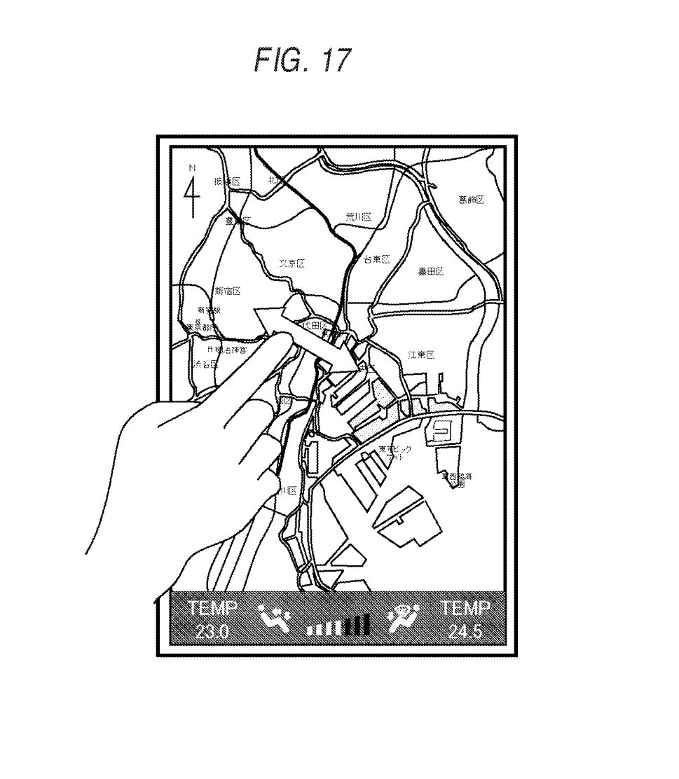

Subsequently, processing of the operation device 10B to cause a tactile sensation when the user operates the operation device 10B will be described. FIG. 17 is a view for explaining a case where the user performs swiping on the touch sensor 15. If the user performs swiping on the touch sensor 15 in a state where a map image is displayed on the display unit 14 as shown in FIG. 17, the map image scrolls in the direction of the swiping by the amount of the swiping.

Specifically, if the user operates the touch sensor 15 with fingers, the operation determining unit 11c acquires information on points touched by the user, and information on the time of the touch. Then, on the basis of the point information and the time information, the operation determining unit 11c derives the number of fingers which the user uses to operate, and the movement speed and acceleration of each finger which is operating.

In a case where the number of fingers which the user uses to operate is one, and the derived acceleration is lower than a predetermined value, the operation determining unit 11c determines that the user's operation is swiping. The predetermined value needs only to be a value making it possible to distinguish between swiping and flicking (to be described below), and can be appropriately set.

Subsequently, the display control unit 11b performs control such that the display unit 14 performs display while scrolling the map image according to the direction and amount of the user's operation. Also, in the present embodiment, in the case where the user performs swiping, the operation device 10B does not cause any tactile sensation.

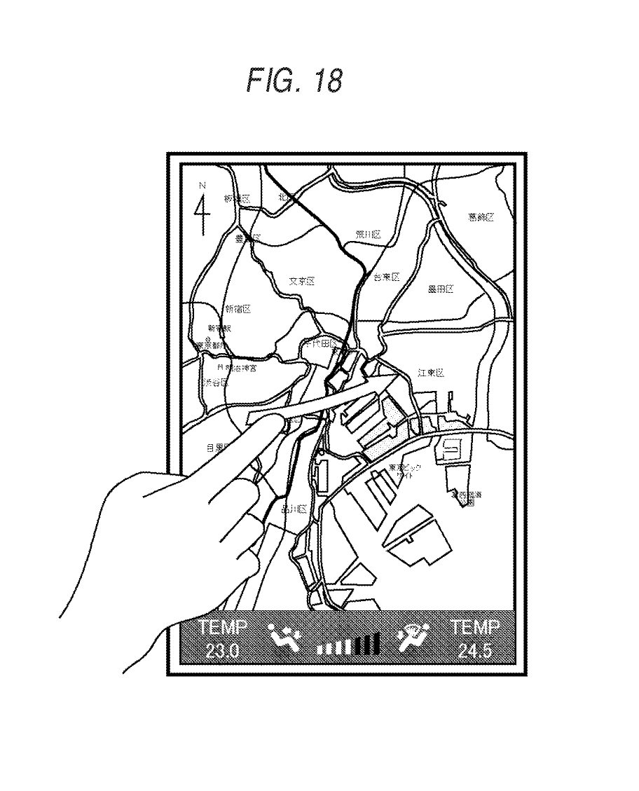

FIG. 18 is a view for explaining a case where the user performs flicking on the touch sensor 15. If the user performs flicking on the touch sensor 15 in a state where a map image is displayed on the display unit 14 as shown in FIG. 18, according to the speed and acceleration of the operation, the map image inertially moves in the direction of the operation.

Specifically, if the user operates the touch sensor 15 with fingers, as described above, the operation determining unit 11c derives the number of fingers which the user uses to operate, and the movement speed and acceleration of each finger which is operating. In a case where the number of fingers which the user uses to operate is one, and the derived acceleration is equal to or higher than the predetermined value, the operation determining unit 11c determines that the user's operation is flicking. Then, the display control unit 11b performs control such that the display unit 14 performs display while inertially moving the map image according to the direction, movement speed, and acceleration of the user's operation.

In the present embodiment, the operation device 10B is configured so as to cause a tactile sensation when the user performs flicking. Specifically, if the operation determining unit 11c determines that the user's operation is flicking, the vibration control unit 11d vibrates the vibrating elements 17 with a constant intensity.

As a result, the vibrating elements 17 ultrasonically vibrate, whereby the surface of the touch sensor 15 ultrasonically vibrates. Since the surface of the touch sensor 15 ultrasonically vibrates, the friction resistance between the user's finger operating the touch sensor 15 and the surface of the touch sensor decreases. Therefore, the user can get a tactile sensation that the surface of the touch sensor is smooth. In other words, if the user starts flicking, the operation device causes a tactile sensation that the surface of the touch sensor is smooth. Therefore, the user can recognize that the operation device has received the flicking.

Also, the operation device 10B is configured so as to output an effect sound corresponding to flicking when the user performs flicking. In the present embodiment, as the effect sound corresponding to flicking, the operation device outputs the sound “shuk”.

The operation device 10B acquires point information even when the user is operating the touch sensor 15. Therefore, after it is determined that the user has started flicking, if it is detected that the user's finger has been separated from the touch sensor 15, the operation device 10B determines that the flicking has finished. At this timing, the operation device 10B reads out the voice data 12e from the memory unit 12, and outputs the sound “shuk”.

That is, if it is determined that the user has started flicking, the operation device 10B causes the tactile sensation that the surface of the touch sensor is smooth, and if it is determined that the flicking has finished, the operation device outputs the effect sound “shuk”. As a result, the user can recognize that the operation device has received the flicking, not only by the tactile sensation but also by the sound.

Also, the operation device 10B may be configured so as to change or stop the tactile sensation if a control value based on the user's operation reaches a limit value such as the upper limit or the lower limit. For example, in the above described example in which if the user performs flicking, the operation device performs display while inertially moving the map image, the tactile sensation is caused while the operation device performs display while inertially moving the map image. However, if an end portion of the map image is displayed and there is no more displayable portion, the operation device changes or stops the tactile sensation. In this case, since the tactile sensation changes, the user can recognize that an end portion of the map image has been displayed, by the tactile sensation.

As another example, there is a configuration in which when an image of a book or a magazine is displayed, if the user performs flicking to turn over a page, the operation device causes a tactile sensation while the page is being turned over, and if the final page is displayed, the operation device changes or stops the tactile sensation. Even in this case, the user can recognize that the final page has been displayed and there is no more page to be turned over, by the tactile sensation.

Further, the operation device 10B may cause a tactile sensation depending on the movement speed of the user's finger when the user performs flicking. For example, whenever the speed of the user's finger performing flicking becomes a predetermined speed, the operation device may cause a tactile sensation different from the tactile sensation that the surface of the touch sensor is smooth.

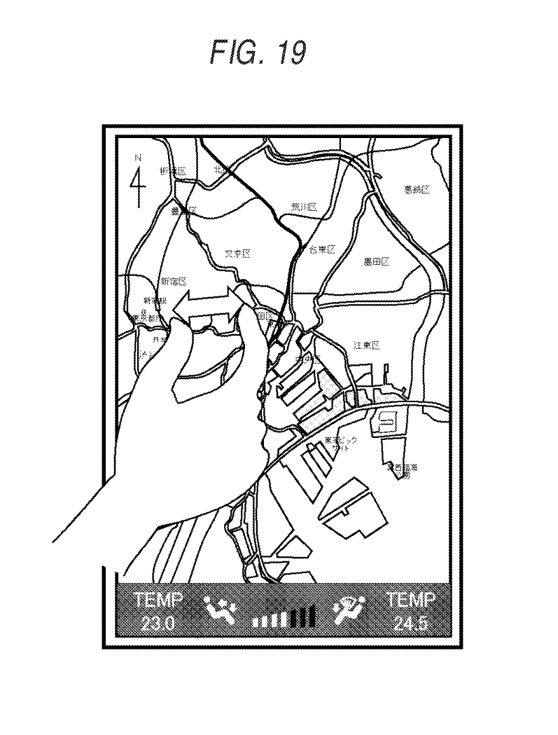

FIG. 19 is a view for explaining a case where the user performs pinching in/out on the touch sensor 15. If the user performs pinching in/out on the touch sensor 15 in a state where a map image is displayed on the display unit 14 as shown in FIG. 19, according to the amount of the user's operation, the map image is reduced or enlarged.

Specifically, if the user operates the touch sensor 15 with fingers, as described above, the operation determining unit 11c derives the number of fingers which the user uses to operate, and the movement speed and acceleration of each finger which is operating. In a case where the number of fingers which the user uses to operate is two, the operation determining unit 11c determines that the user's operation is pinching in/out.

If the operation determining unit 11c determines that the user's operation is pinching in/out, on the basis of variations in the point information on two points at which the user is operating the touch sensor 15, the display control unit 11b reduces or enlarges the map image and performs control such that the display unit 14 displays the reduced or enlarged map image.

In the present embodiment, the operation device 10B is configured so as to cause a tactile sensation when the user performs pinching in/out. That is, if the operation determining unit 11c determines that the user's operation is pinching in/out, the vibration control unit 11d vibrates the vibrating elements 17 with a constant intensity.

In this way, the vibrating elements 17 ultrasonically vibrate, whereby the surface of the touch sensor 15 ultrasonically vibrates. As described above, since the surface of the touch sensor 15 ultrasonically vibrates, the user can get a tactile sensation that the surface of the touch sensor is smooth. In other words, if the user starts pinching in/out, the operation device causes a tactile sensation that the surface of the touch sensor is smooth.

Also, in the present embodiment, the operation device 10B is configured so as to give a click tactile sensation whenever pinching in/out is performed by a predetermined amount if the user performs pinching in/out. This predetermined amount is, for example, a predetermined reduction or enlargement amount. In a case where there is a map image displayed, as the predetermined amount, a certain scale can be set.

Specifically, with start of pinching in/out, the vibrating elements 17 vibrate, thereby causing the tactile sensation that the surface of the touch sensor is smooth. In this state, if the user's operation is performed by the predetermined amount, the operation device stops the vibration of the vibrating elements 17. As a result, the surface of the touch sensor 15 becomes a high friction state, whereby the user gets a click tactile sensation. Then, if the user keeps pinching in/out, the vibrating elements 17 restarts to vibrate, whereby the user gets a tactile sensation that the surface of the touch sensor is smooth.

In this way, in a case where the user performs pinching in/out, it is possible to give a click tactile sensation at intervals of the predetermined operation amount while giving a tactile sensation that the surface of the touch sensor is smooth. Therefore, the user can recognize that the operation device has received the pinching in/out, and can also recognize the amount of the pinching in/out.

Also, the operation device 10B is configured so as to output an effect sound corresponding to pinching in/out when the user performs pinching in/out. Specifically, when causing the click tactile sensation, the operation device outputs an effect sound “pik”. In other words, at a timing to cause the click tactile sensation, the operation device 10B reads out the voice data 12e from the memory unit 12, and outputs the effect sound “pik”. Therefore, the user can recognize the amount of the operation, not only by the tactile sensation but also by the sound.

Also, the operation device 10B may be configured so as to change or stop the tactile sensation if a control value based on the user's operation reaches a limit value such as the upper limit or the lower limit. For example, in the above described example in which if the user performs pinching in/out, the map image is reduced or enlarged, the tactile sensation is caused while the map image is reduced or enlarged. However, if the reduction or enlargement ratio reaches a limit value, the operation device changes or stops the tactile sensation.

### 4-3. Processing of Operation Device

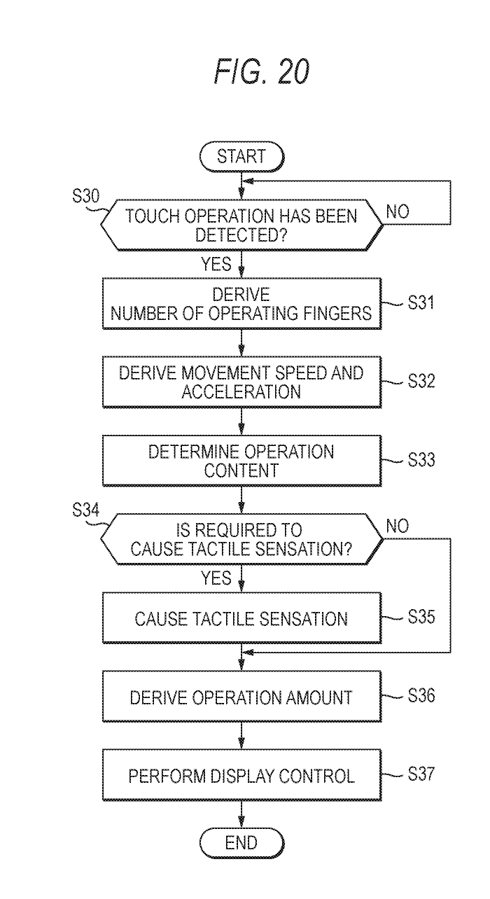

Subsequently, processing of the operation device 10B will be described. FIG. 20 is a flow chart illustrating the processing of the operation device 10B. If the operation device 10B it is powered on, thereby being activated, it starts the process. In STEP S30, the operation device 10B monitors whether a touch operation of the user has been detected while being in a standby state until a user's operation is detected. Specifically, the operation device 10B monitors whether the touch detecting unit 16a has detected a touch of the user on the touch sensor 15.

In a case where any touch operation has not been detected (“No” in STEP S30), the operation device 10B monitors whether a touch operation has been detected, again. Meanwhile, in a case where a touch operation has been detected (“Yes” in STEP S30), in STEP S31, the operation device 10B derives the number of fingers operating. Specifically, the operation device 10B acquires the point information (for example, an X coordinate and a Y coordinate) acquired during the start of the user's operation on the touch sensor 15, and derives the number of fingers which the user uses to operate, on the basis of the point information.

Subsequently, in STEP S32, the operation device 10B derives the movement speed and acceleration of each finger which the user uses to operate. Specifically, the operation device 10B acquires the point information on points where the user started the operation on the touch sensor 15, and time information on the operation start time, and derives the movement speed and acceleration of each finger on the basis of the point information and the time information.

Subsequently, in STEP S33, the operation device 10B determines the content of the operation. In a case where the number of fingers derived in STEP S31 is two, the operation device 10B determines that the user is performing pinching in/out. In contrast to this, in a case where the number of fingers derived in STEP S31 is one, the operation device 10B determines the content of the operation on the basis of the acceleration derived in STEP S32. Specifically, in a case where the acceleration is lower than the predetermined value, the operation device 10B determines that the user is performing swiping; whereas, in a case where the acceleration is equal to or higher than the predetermined value, the operation device determines that the user is performing flicking.

Subsequently, in STEP S34, the operation device 10B determines whether to cause a tactile sensation. In the present embodiment, in a case where the user is performing swiping, the operation device does not cause any tactile sensation; whereas, in a case where the user is performing flicking or pinching in/out, the operation device causes the tactile sensation. Therefore, in the case where the determined operation content is swiping, the operation device 10B determines not to cause any tactile sensation (“No” in STEP S34), and then proceeds to an operation amount deriving process.

Meanwhile, in the case where the determined operation content is flicking or pinching in/out, the operation device 10B determines to cause the tactile sensation (“Yes” in STEP S34), and then performs a process of causing the tactile sensation in STEP S35. Specifically, if the operation device 10B determines that the user's operation is flicking or pinching in/out, the vibrating elements 17 vibrate, thereby causing the tactile sensation that the surface of the touch sensor is smooth. Also, in the case where the user's operation is pinching in/out, at intervals of the predetermined reduction or enlargement amount, the operation device 10B controls the vibrating elements 17, thereby causing the tactile sensation that the surface of the touch sensor is smooth.

Subsequently, in STEP S36, the operation device 10B derives the amount of the user's operation. The operation device 10B acquires point information even when the user is operating the touch sensor 15, and derives the amount of the user's operation at that moment. That is, the touch detecting unit 16a regularly acquires point information at predetermined timings, and the operation device 10B derives the amount (movement amount) of the user's operation on the basis of the point information of each timing.

Subsequently, in STEP S37, the operation device 10B performs display control on the basis of the amount of the user's operation derived. In other words, the display control unit 11b performs control such that a display screen according to the amount of the user's operation is displayed. Specifically, for example, in a case where there is a map image displayed, when the user is performing swiping, the operation device scrolls the map image according to the amount of the swiping; whereas when the user is performing flicking, the operation device inertially moving the map image according to the amount of the flicking. Also, when the user is performing pinching in/out, the operation device reduces or enlarges the map image according to the amount of the pinching. Also, when the operation device 10B is performing the process of causing the tactile sensation, if the control value based on the user's operation reaches a limit value, the operation device changes or stops the tactile sensation. Specifically, in some cases such as a case where the map image moves such that its one end portion is displayed or a case where the map image is minimized or maximized, the operation device 10B changes the vibration state of the vibrating elements 17, thereby causing a different tactile sensation, or stops the vibration of the vibrating elements 17, thereby stopping to cause the tactile sensation.

Also, although not shown in the flow chart of FIG. 20, in the case where the user performs flicking or pinching in/out, the operation device 10B performs a process of outputting an effect sound corresponding thereto, at a predetermined timing.

In this way, the operation device causes a tactile sensation according to the content of a user's operation. Therefore, the user can intuitively recognize whether the operation device has received the content of an operation intended by the user. Also, if the operation device causes different tactile sensations depending on the amounts of operations, the user can also intuitively recognize the amount of a user's operation.

### 5. Fourth Embodiment

Subsequently, a fourth embodiment will be described. In the third embodiment described above, according to the content of a user's operation on the touch sensor 15, the operation device causes a tactile sensation. However, the present invention is not limited thereto. For example, the present invention may be implemented such that an operation device causes a tactile sensation in a case where a user operates a specific area of the touch sensor 15. Hereinafter, an operation device which causes a tactile sensation in a case where a user operates a specific area will be described with a focus on differences from the third embodiment.

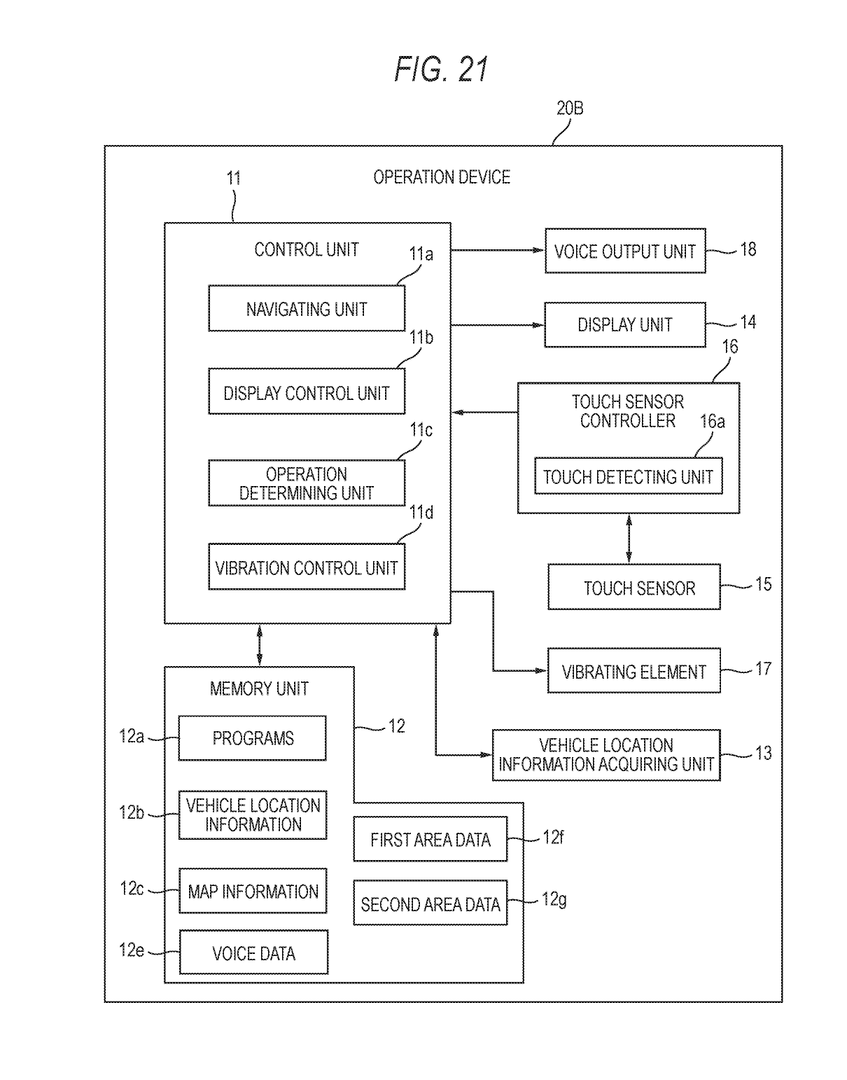

FIG. 21 is a view illustrating the outline of the configuration of an operation device 20B according to the fourth embodiment. As shown in FIG. 21, the operation device 20B is different from the operation device 10B of the third embodiment described with reference to FIG. 15 in that the memory unit 12 retains data (first area data 12f and second area data 12g) on a specific area to cause tactile sensations. Also, the operation device 20B is different from the operation device 10B in that the operation determining unit 11c considers the specific areas in determining the content of a user's operation. The other components are identical to those of the operation device 10B described in the third embodiment, and thus will not be described in detail.

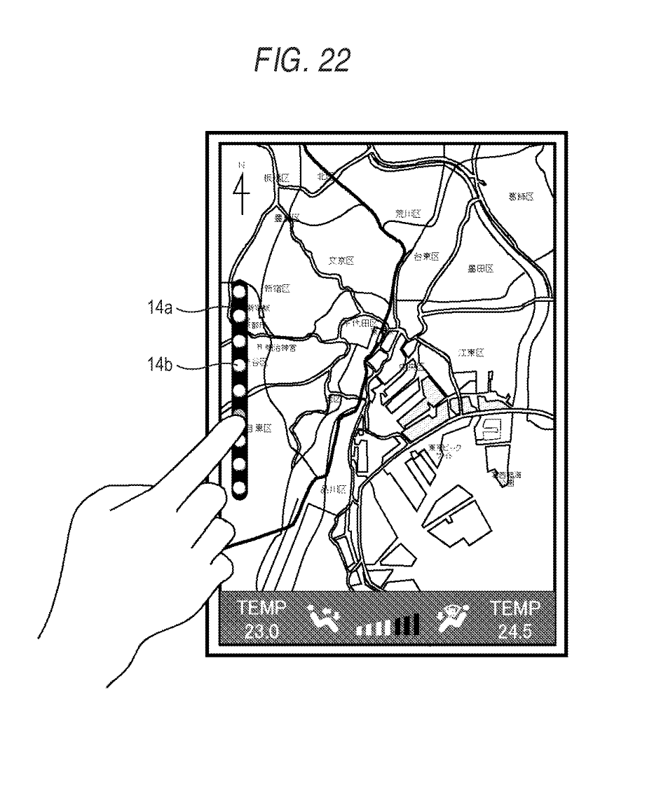

FIG. 22 is a view for explaining a case where the user operates the touch sensor 15. As shown in FIG. 22, a map image is displayed on the display unit 14, and a scale bar 14a for changing the scale of the map image is displayed at a portion of the display unit. In the present embodiment, if the user operates a specific area on the screen, the operation device causes a tactile sensation. In the example of FIG. 22, the area where the scale bar 14a is displayed is a specific area. Hereinafter, a specific area to cause a tactile sensation will be referred to as a specific area or a first area.

That is, the memory unit 12 retains point information corresponding to the area where the scale bar 14a is displayed, as specific area information (the first area data 12f). Therefore, the operation determining unit 11c compares the point information acquired during the start of the user's operation on the touch sensor 15, with the first area data 12f, thereby determining whether the operated point is included in the specific area. In a case where the operated point is included in the specific area, the vibration control unit 11d vibrates the vibrating elements 17, thereby causing a first tactile sensation. The first tactile sensation is, for example, a tactile sensation that the surface of the touch sensor is smooth.

Also, on the scale bar 14a, scale marks 14b indicating scales are displayed at regular intervals. Then, if the user touches the area where the scale marks 14b is displayed in order to perform swiping on the scale bar 14a, thereby changing the scale, the operation device causes a second tactile sensation different from the first tactile sensation described above. The second tactile sensation is, for example, a click tactile sensation.

That is, the memory unit 12 further retains point information (the second area data 12g) corresponding to the area (hereinafter, referred to as the second area) where the scale marks 14b are displayed. Therefore, if the user operates the touch sensor 15, the operation determining unit 11c compares the point information acquired during the start of the user's operation on the touch sensor 15, with the second area data 12g. Then, in a case where the operation point is included in the second area, the vibration control unit 11d vibrates the vibrating elements 17, thereby causing the second tactile sensation.

Also, when causing the second tactile sensation, the operation device outputs a corresponding effect sound. Specifically, at a timing to cause the click tactile sensation, the operation device 20B reads out the voice data 12e from the memory unit 12, and outputs the effect sound “pik”.

Also, the operation device may be configured so as to change or stop the tactile sensation in a case where the user exceeds the lower or upper limit value of the scale when the user performs swiping on the scale marks 14b for changing the scale. For example, in a case where the point which is operated by the user is on the scale bar 14a and indicates a scale available for reduction or enlargement, the operation device applies the scale indicated by the corresponding point while giving the first tactile sensation or the second tactile sensation. However, from this state, if the user keeps the operation beyond the upper or lower limit value of the scale, the operation device changes or stops the tactile sensation having been caused. In this case, the vibration control unit 11d changes the vibration state of the vibrating elements 17, or stops the vibration.

As described above, if the user operates the specific area, the corresponding tactile sensation is caused. Therefore, the user can recognize that the user is operating the specific area. Also, even when the user operates the specific area, the operation device may cause different tactile sensations depending on the scale marks displayed at regular intervals. In this case, the user can recognize the amount of the operation. Also, since the operation device outputs a corresponding effect sound, the user can recognize the amount of the operation, not only by the tactile sensation but also by the sound. Further, in the case where the control value exceeds the upper or lower limit value, since the operation device changes the tactile sensation, the user can recognize that an operation (such as an operation for reduction or enlargement) beyond the limit is impossible, by the tactile sensation.

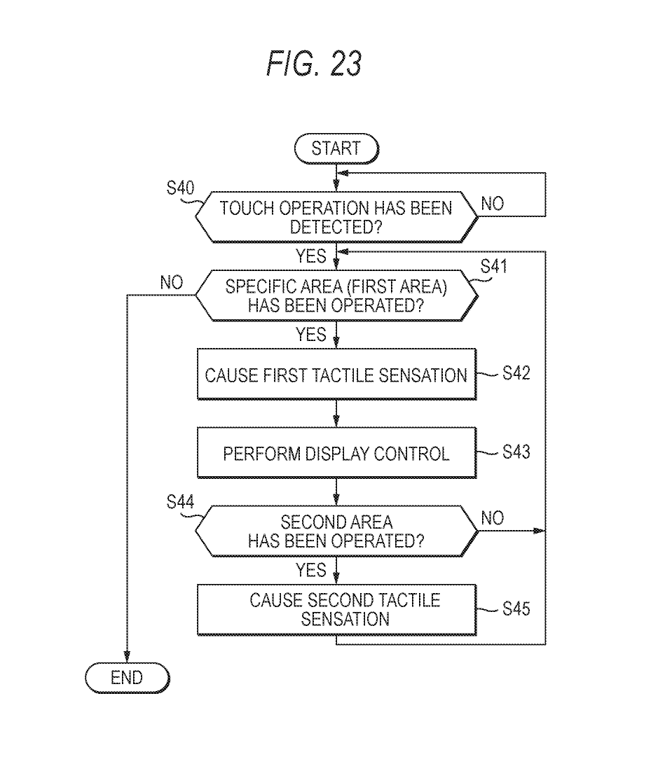

FIG. 23 is a flow chart illustrating processing of the operation device 20B according to the present embodiment. The operation device 20B of the present embodiment also starts the processing if it is powered on so as to be active. Also, if the operation device 20B is activated, the map image and the scale bar 14a are displayed on the display unit 14.

In STEP S40, the operation device 20B monitors whether a touch operation of the user has been detected while being in a standby state until a user's operation is received. Specifically, the operation device 20B monitors whether the touch detecting unit 16a has detected a touch of the user on the touch sensor 15.

In a case where any touch operation has not been detected (“No” in STEP S40), the operation device 20B monitors whether a touch operation has been detected, again. Meanwhile, in a case where a touch operation has been detected (“Yes” in STEP S40), in STEP S41, the operation device 20B determines whether the specific area has been operated. Specifically, the operation device 20B compares point information acquired when the user started the operation on the touch sensor 15, with the first area data 12f retained in the memory unit 12, thereby determining whether the operated point is included in the specific area.

Then, in a case where the operated point is not included in the specific area (“No” in STEP S41), the operation device finishes the processing. Meanwhile, in a case where the operated point is included in the specific area (“Yes” in STEP S41), if the user is operating the scale bar 14a, in STEP S42, the operation device 20B causes the first tactile sensation. That is, the operation device vibrates the vibrating elements 17 with a constant intensity, thereby causing the tactile sensation that the surface of the touch sensor is smooth.

Subsequently, in STEP S43, the operation device 20B performs display control. That is, on the basis of the scale change instruction based on the user's operation, the operation device enlarges or reduces the map image and displays the enlarged or reduced map image.

Subsequently, in STEP S44, the operation device 20B determines whether the user has operated the second area. The operation device 20B compares the point information acquired when the user started the operation on the touch sensor 15, with the second area data 12g retained in the memory unit 12, thereby determining whether the operated point is included in the second area.

Then, in a case where the operated point is not included in the second area (“No” in STEP S44), in STEP S41, the operation device 20B determines whether the specific area has been operated, again. Meanwhile, in a case where the operated point is included in the second area (“Yes” in STEP S44), in STEP S45, the operation device 20B causes the second tactile sensation. That is, the operation device stops the vibration of the vibrating elements 17, thereby causing the click tactile sensation. Also, at this time, the operation device 20B outputs a corresponding effect sound. Subsequently, in STEP S41, the operation device 20B determines whether the specific area has been operated, again.

Also, although not shown in the flow chart of FIG. 23, in a state where the user operates the scale bar 14a, if the user operates an area (a third area) beyond the upper and lower limit values of the scale, the operation device 20B performs a process of changing or stopping the tactile sensation. Specifically, in a situation where the user is operating the first area, if the user operates a point beyond the upper or lower limit value of the scale, the operation device changes the vibration state or stops the vibration. In the case of performing changing from the tactile sensation to another tactile sensation, another tactile sensation may be a tactile sensation different from the first tactile sensation and the second tactile sensation, or may be the second tactile sensation.

As described above, if the user operates the specific area (the scale bar 14a) in order to change the scale of the display image, the operation device causes a corresponding tactile sensation. Therefore, the user can intuitively recognize that the user is operating the specific area. Also, since the operation device causes different tactile sensations depending on the scale marks displayed at regular intervals in the specific area, the user can intuitively recognize the amount of the operation.

### 6. Modifications

Although the third and fourth embodiments of the present invention have been described above, the present invention is not limited to the embodiments, and can be modified in various forms. Hereinafter, these modifications will be described. All forms including the embodiments described above and the following forms to be described below can be appropriately combined.

In each embodiment described above, in a case where the user performs swiping on the touch sensor 15, the operation device does not cause any tactile sensation. However, the present invention is not limited thereto. The operation device may be configured so as to give a tactile sensation that the surface of the touch sensor is smooth even in the case where the user performs swiping.

In this case, if the operation determining unit 11c determines that the user's operation is swiping, for example, the vibration control unit 11d vibrates the vibrating elements 17 with a constant intensity, whereby the operation device can give a tactile sensation that the surface of the touch sensor is smooth. As a result, the user can recognize that the operation device has received the swiping.

Also, the operation device may give a different tactile sensation when the user completes swiping. For example, if the movement of the user's finger operating the touch sensor 15 stops, the operation device determines that swiping has been completed, and performs a corresponding process such as a process of stopping the vibration of the vibrating elements 17. In this way, the operation device can give a click tactile sensation to the user. As a result, the user can recognize that the swiping has been completed.

Also, when the user completes the swiping, the operation device may output a corresponding effect sound. In this case, for example, at the timing when the operation device determines that the swiping has been completed, the operation device reads out the voice data 12e from the memory unit 12, and outputs the sound “shuk”.

Also, in each above described embodiment, various functions are implemented in a software wise by arithmetic processing of the CPU according to programs. However, some of those functions may be implemented by electric hardware circuits. Also, conversely, some of functions which are implemented by hardware circuits may be implemented in a software wise.

What is claimed is:

1. An operation device, comprising:
a touch sensor;
a deriving unit that acquires information representing a point on the touch sensor subjected to an operation, and derives an amount of the operation on the basis of the point information; and
a tactile sensation giving unit that gives a tactile sensation to an operator,
wherein the tactile sensation giving unit gives a first tactile sensation at intervals of a first operation amount from an operation start point.

2. The operation device according to claim 1, wherein:
the tactile sensation giving unit gives a second tactile sensation different from the first tactile sensation at intervals of a second operation amount different from the first operation amount.

3. The operation device according to claim 1, further comprising:
a voice output unit that outputs a voice,
wherein, in response to the tactile sensation giving unit giving the tactile sensation, the voice output unit outputs a voice corresponding to a type of the given tactile sensation.

4. An operation device, comprising:
a touch sensor;
a deriving unit that acquires information representing a point on the touch sensor subjected to an operation, and derives an amount of the operation on the basis of the point information; and
an adjusting unit that changes an adjustment value of another electronic device,
wherein, the adjusting unit perform an adjustment in accordance with the operation amount from an operation start point, from a current adjustment value a point of which is set to be associated with the operation start point.

5. An operation device, comprising:
a touch sensor;
a deriving unit that acquires information representing a point on the touch sensor subjected to an operation, and derives an amount of the operation on the basis of the point information; and
an adjusting unit that changes an adjustment value of another electronic device,
wherein, the adjusting unit performs an adjustment in accordance with the operation amount from an operation start point, from a adjustment value corresponding to a point of which is determined in advance and corresponds to an operation start point.

6. An operation device, comprising:
a touch sensor;
a deriving unit that acquires information representing a point on the touch sensor subjected to an operation, and derives an amount of the operation on the basis of the point information; and
an adjusting unit that changes an adjustment value of another electronic device,
wherein, the adjusting unit perform an adjustment in accordance with the operation amount from an operation start point, from an adjustment value a point of which is determined according to a trajectory of the operation and corresponds to an operation start point.

7. The operation device according to claim 4, further comprising:
a tactile sensation giving unit that gives a tactile sensation to an operator.

8. The operation device according to claim 7, wherein:
the tactile sensation giving unit gives the tactile sensation whenever the operation is performed by a predetermined amount.

9. The operation device according to claim 8, wherein:
the tactile sensation giving unit changes the predetermined amount depending on an operation target.

10. The operation device according to claim 7, further comprising:
a voice output unit that outputs a voice,
wherein, in response to the tactile sensation giving unit giving the tactile sensation, the voice output unit outputs the voice corresponding to a type of the given tactile sensation.

11. An operation device, comprising:
a touch sensor;
a determining unit that determines a content of an operation on the touch sensor; and
a tactile sensation giving unit that gives a tactile sensation to an operator,
wherein, in response to the determining unit determining start of the operation on the touch sensor, the tactile sensation giving unit gives the tactile sensation corresponding to the content of the operation.

12. The operation device according to claim 11, wherein:
in response to the determining unit determining finish of the operation on the touch sensor, the tactile sensation giving unit gives a tactile sensation different from the tactile sensation given during the start of the operation.

13. The operation device according to claim 12, further comprising:
a voice output unit that outputs a voice,
wherein, in response to the tactile sensation giving unit gives the tactile sensation during the finish of the operation, the voice output unit outputs the voice corresponding to a type of the given tactile sensation.

14. The operation device according to claim 11, wherein:
the determining unit acquires information representing a point on the touch sensor subjected to the operation, and derives an amount of the operation on the basis of the point information, and
at intervals of a predetermined operation amount, the tactile sensation giving unit gives a tactile sensation different from the tactile sensation given during start of the operation.

15. The operation device according to claim 14, further comprising:
a voice output unit that outputs a voice,
wherein, in response to the tactile sensation giving unit giving the tactile sensation at intervals of the predetermined operation amount, the voice output unit outputs a voice corresponding to a type of the given tactile sensation.

16. The operation device according to claim 11, wherein:
the determining unit acquires information representing a point on the touch sensor subjected to the operation, and information representing time of the operation, and derives a speed of the operation on the basis of the point information and the time information, and
at intervals of a predetermined operation speed, the tactile sensation giving unit gives a tactile sensation different from the tactile sensation given during start of the operation.

17. The operation device according to claim 16, further comprising:
a voice output unit that outputs a voice,
wherein, in response to the tactile sensation giving unit giving the tactile sensation at intervals of the predetermined operation speed, the voice output unit outputs the voice corresponding to the given tactile sensation.

18. The operation device according to claim 11, wherein:
in the touch sensor, a first area and another area are determined in advance, such that in response to the first area being operated, a tactile sensation is given, and in response to said another area being operated, any tactile sensation is not given, and
in response to the first area being operated, the tactile sensation giving unit gives a first tactile sensation.

19. The operation device according to claim 18, wherein:
in the first area, a second area is determined in advance, such that in response to the second area being operated, a second tactile sensation different from the first tactile sensation is given, and
in response to the second area being operated, the tactile sensation giving unit gives the second tactile sensation.

20. The operation device according to claim 11, wherein:
in a case where the operation on the touch sensor is an operation for adjusting a setting of the operation device or another device, in response to the operation on the touch sensor reaching an upper or lower limit value of a setting range, the tactile sensation giving unit gives a tactile sensation different from the tactile sensation given during the start of the operation, or stops giving the tactile sensation.
